(19) United States
(12) Patent Application Publication
(10) Pub. No.: US 2024/0370286 A1
(43) Pub. Date: Nov. 7, 2024

(54) COMPOSITE AND REBOOT-AWARE HEALTH CHECKING OF CONTAINERIZED APPLICATIONS

(71) Applicant: GE Precision Healthcare LLC, Wauwatosa, WI (US)

(72) Inventors: Venkatesh Pandi, Bangalore (IN); Gajanan Rameshwar More, Bangalore (IN)

(21) Appl. No.: 18/311,593

(22) Filed: May 3, 2023

(51) Int. Cl. G06F 9/455

(52) U.S. Cl. CPC G06F 9/45558; G06F 2009/45591

(57) ABSTRACT

Systems/techniques that facilitate composite and reboot-aware health checking of containerized applications are provided. In various embodiments, a system can access a containerized application, wherein the containerized application can include a set of services that respectively expose a set of pluralities of containerized objects. In various aspects, the system can perform, in response to an electronic command and for each containerized object in the set of pluralities of containerized objects, a respective reboot-aware health check, thereby yielding a set of pluralities of object-level health statuses. In various instances, the system can generate an application-level health status based on the set of pluralities of object-level health statuses. In various cases, the system can render the application-level health status on an electronic display.

### TECHNICAL FIELD

The subject disclosure relates generally to containerized applications, and more specifically to composite and reboot-aware health checking of containerized applications.

### BACKGROUND

A containerized application can include many different services that each expose many different containerized objects. Health status information pertaining to the containerized application can be leveraged to determine whether or not maintenance of the containerized application is warranted. Existing containerization techniques only support calling the health status of each containerized object of the containerized application independently or individually. Unfortunately, such existing containerization techniques can be considered as excessively time-consuming and as insufficiently helpful for debugging or troubleshooting.

Accordingly, systems or techniques that can address one or more of these technical problems can be considered as desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate composite and reboot-aware health checking of containerized applications are described.

According to one or more embodiments, a system is provided. The system can comprise a processor that can execute computer-executable components stored in a non-transitory computer-readable memory. In various aspects, the computer-executable components can comprise an access component that can access a containerized application, wherein the containerized application can include a set of services that respectively expose a set of pluralities of containerized objects. In various instances, the computer-executable components can comprise a status component that can perform, in response to an electronic command and for each containerized object in the set of pluralities of containerized objects, a respective reboot-aware health check, thereby yielding a set of pluralities of object-level health statuses, and that can generate an application-level health status based on the set of pluralities of object-level health statuses. In various cases, the computer-executable components can comprise an execution component that can render the application-level health status on an electronic display.

According to one or more embodiments, a computer-implemented method is provided. In various embodiments, the computer-implemented method can comprise accessing, by a device operatively coupled to a processor, a containerized application, wherein the containerized application can include a set of services that respectively expose a set of pluralities of containerized objects. In various aspects, the computer-implemented method can comprise performing, by the device, in response to an electronic command, for each containerized object in the set of pluralities of containerized objects, a respective reboot-aware health check, thereby yielding a set of pluralities of object-level health statuses. In various instances, the computer-implemented method can comprise generating, by the device, an application-level health status based on the set of pluralities of object-level health statuses. In various cases, the computer-implemented method can comprise rendering, by the device, the application-level health status on an electronic display.

According to one or more embodiments, a computer program product for facilitating composite and reboot-aware health checking of containerized applications is provided. In various aspects, the computer program product can comprise a non-transitory computer-readable memory having program instructions embodied therewith. In various instances, the program instructions can be executable by a processor to cause the processor to access a containerized application hosted on a medical imaging scanner, wherein the containerized application can include a set of services that respectively expose a set of pluralities of containerized objects. In various instances, the program instructions can be further executable to cause the processor to perform, in response to an electronic command and for each containerized object in the set of pluralities of containerized objects, a respective health check that takes into account a most-recent reboot time of the medical imaging scanner, thereby yielding a set of pluralities of object-level health statuses. In various cases, the program instructions can be further executable to cause the processor to generate a health report based on the set of pluralities of object-level health statuses.

### DESCRIPTION OF THE DRAWINGS

FIG. 1 illustrates a block diagram of an example, non-limiting system that facilitates composite and reboot-aware health checking of containerized applications in accordance with one or more embodiments described herein.

FIG. 2 illustrates an example, non-limiting block diagram showing services exposing containerized objects in accordance with one or more embodiments described herein.

FIG. 3 illustrates a block diagram of an example, non-limiting system including a set of object-level health statuses that facilitates composite and reboot-aware health checking of containerized applications in accordance with one or more embodiments described herein.

FIG. 4 illustrates an example, non-limiting block diagram of a set of pluralities of object-level health statuses in accordance with one or more embodiments described herein.

FIG. 5 illustrates a block diagram of an example, non-limiting system including a set of service-level health statuses that facilitates composite and reboot-aware health checking of containerized applications in accordance with one or more embodiments described herein.

FIG. 6 illustrates an example, non-limiting block diagram showing how a set of service-level health statuses can be obtained from a set of pluralities of object-level health statuses in accordance with one or more embodiments described herein.

FIG. 7 illustrates a block diagram of an example, non-limiting system including an application-level health status that facilitates composite and reboot-aware health checking of containerized applications in accordance with one or more embodiments described herein.

FIG. 8 illustrates an example, non-limiting block diagram showing how an application-level health status can be obtained from a set of service level health statuses in accordance with one or more embodiments described herein.

FIG. 9 illustrates a block diagram of an example, non-limiting system including a health report and a maintenance call that facilitates composite and reboot-aware health checking of containerized applications in accordance with one or more embodiments described herein.

FIGS. 10-13 illustrate flow diagrams of example, non-limiting computer-implemented methods that facilitate composite and reboot-aware health checking of containerized applications in accordance with one or more embodiments described herein.

FIG. 14 illustrates an example, non-limiting screenshot of containerized application health statuses that can be visually rendered in accordance with one or more embodiments described herein.

FIG. 15 illustrates a flow diagram of an example, non-limiting computer-implemented method that facilitates composite and reboot-aware health checking of containerized applications in accordance with one or more embodiments described herein.

FIG. 16 illustrates a block diagram of an example, non-limiting operating environment in which one or more embodiments described herein can be facilitated.

FIG. 17 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A containerized application can be hosted on a computing device (e.g., can be hosted on any suitable computer-executable hardware comprising one or more processors). In various aspects, the containerized application can be any suitable computer-executable software that can be organized into isolated runtime environments called containers that encapsulate the computer-executable software with its dependencies (e.g., with whatever system libraries, binaries, or configuration files on which the software relies). Accordingly, the containerized application can be considered as being modular, portable, self-contained, or otherwise not dependent upon any particular underlying hardware (e.g., the containerized application can be implemented across computing devices, regardless of those computing devices' unique properties, characteristics, or attributes). The containerized application can be configured or managed via any suitable container orchestration platform, such as Kubernetes or Docker swarm. Furthermore, the containerized application can implement any suitable container runtime, such as Docker, runC, containerd, or Windows Containers. Further still, the containerized application can implement any suitable package manager, such as Helm.

The containerized application can include various services, where each service can be considered as a method or abstraction that exposes a respective set of containerized objects to external/front-end computing clients or to other services within or outside the containerized application. A containerized object can be any suitable discrete or definable resource of the containerized application, such as: a pod; a container within a pod; a persistent volume within a pod; a deployment, stateful set, replica set, or daemon set that specifies desired states of one or more pods; a job or cronjob to be performed by one or more pods; or a custom resource definition (crd).

Health status information pertaining to the containerized application can be leveraged to determine whether or not maintenance of the containerized application is warranted. For example, suppose that it is known that a particular containerized object of the containerized application is operating unhealthily (e.g., suppose that such particular containerized object has a health status of NOT RUNNING or NOT IN COMPLIANCE). In such case, maintenance for such particular containerized object can be recommended or scheduled.

Existing containerization techniques only support calling the health status of each containerized object of the containerized application independently or individually. Unfortunately, such existing containerization techniques can be considered as excessively time-consuming and as insufficiently helpful for debugging or troubleshooting. For example, suppose that the containerized application comprises multiple services, with each service exposing tens or even hundreds of containerized objects. In such case, a user or operator that is attempting to debug or troubleshoot the containerized application or to otherwise determine whether maintenance of the containerized application is warranted would have to manually call the health status of each containerized object to identify which, if any, are operating unhealthily. Such manual calling can be excessively tedious and tiresome for the user or operator. Additionally, such manual calling can be considered as unfocused or otherwise undirected. In other words, existing containerization techniques do not provide any targeted guidance to the user or operator regarding which containerized objects should be checked, and so the user or operator has no choice but to aimlessly, randomly, or exhaustively check the health statuses of the containerized objects.

Furthermore, the inventors of various embodiments described herein recognized a previously-unknown problem that can afflict health checking of existing containerization techniques. In particular, the present inventors discovered that the health statuses called by existing containerization techniques can be stale, inconsistent, unstable, or otherwise inaccurate when a computing device hosting the containerized application has recently been rebooted. Specifically, the present inventors realized the following: upon reboot of the computing device, the containerized application can automatically restore itself with its previous (e.g., pre-reboot) configuration or state information (e.g., such restoration is not a fresh start from scratch); within a threshold amount of time (e.g., 30 seconds) after the reboot and restoration, the containerized application can automatically kill all of its services and thus all of its containerized objects; and, after killing the services and containerized objects, the containerized application can automatically start from scratch all of the services and containerized objects with default configuration or state information.

The present inventors realized that, if existing containerization techniques called the health status of a specific containerized object after the computing device had been rebooted but before that specific containerized object had been killed and freshly started by the containerized application, the obtained health status could be considered as stale. For example, suppose that the specific containerized object had been operating healthily (e.g., had a health status of RUNNING or IN COMPLIANCE) prior to the reboot of the computing device. After the reboot (and thus the restoration) but before the kill-and-start, a health check performed by existing containerization techniques would conclude that the specific containerized object is still operating healthily (e.g., still has a health status of RUNNING or IN COMPLIANCE). However, this healthy operation would be quickly interrupted or terminated by the succeeding kill-and-start. Accordingly, if the specific containerized object attempted to perform a job or other operation during the interim period between the reboot and the kill-and-start, where such job or other operation would consume more time than available during such interim period, significant computing errors would occur. Indeed, experiments performed by the present inventors confirmed such significant computing errors in a medical or clinical operational context where the containerized application was a medical imaging software program running on a medical imaging scanner. In particular, after reboot of the scanner, a medical imaging scan was quickly initiated but then suddenly interrupted by the kill-and-start, resulting in myriad errors. As mentioned above, the present inventors discovered this previously-unknown failure of existing containerization techniques.

Therefore, existing containerization techniques for performing health status checking of containerized applications can be excessively time-consuming, can fail to provide any targeted guidance to users or operators, and can experience significant failures in the presence of recent console reboots.

Accordingly, systems or techniques that can address one or more of these technical problems can be desirable.

Various embodiments described herein can address one or more of these technical problems. One or more embodiments described herein can include systems, computer-implemented methods, apparatus, or computer program products, that can facilitate composite and reboot-aware health checking of containerized applications. In other words, the present inventors devised various automated techniques for facilitating health status checking of containerized applications, which automated techniques are less time-consuming and aimless as compared to existing containerization techniques, and which automated techniques can stably report health statuses even in the presence of recent console reboots.

In particular, such automated techniques can involve performing, in response to a user command requesting a health status of the containerized application, a reboot-aware health check on each containerized object of an application. In various aspects, a reboot-aware health check of a containerized object can involve determining whether a most recent start time/date of the containerized object is earlier or later than a most recent reboot time/date of a computing device hosting the containerized application. If the most recent start time/date of the containerized object is later than the most recent reboot time/date, then a health status of the containerized object can be called or queried: such health status can indicate either healthy or unhealthy operation. However, if the most recent start time/date is instead earlier than the most recent reboot time/date, then a health status indicating unhealthy operation can be automatically assigned to or otherwise generated for the containerized object. Note that such a reboot-aware health check can ensure that the containerized object has a health status indicating unhealthy operation, whenever the check is performed during the interim between a reboot and the subsequent kill-and-start mentioned above. In other words, the reboot-aware health check can be considered as not falsely or stalely reporting healthy operation during such interim, in stark contrast to existing containerization techniques.

In any case, performance of a reboot-aware health check on each containerized object can yield multiple object-level health statuses (e.g., one object-level health status per containerized object). Moreover, the automated techniques described herein can involve aggregating such multiple object-level health statuses into a set of service-level health statuses, where each service-level health status can be considered as a composite combination of a respective subset of the multiple object-level health statuses. Furthermore, such automated techniques can involve aggregating the set of service-level health statuses into an application-level health status. Further still, such automated techniques can involve rendering the application-level health status on an electronic display to be viewed by a user or operator. In various aspects, the application-level health status can be considered as a single, easy-to-understand indicator representing the overall or total health of the containerized application. Likewise, a service-level health status can be considered as a single, easy-to-understand indicator representing the overall or total health of a respective service of the containerized application. In some cases, such automated techniques can involve rendering, on the electronic display and in conjunction with the application-level health status, whichever service-level health statuses or object-level health statuses that indicate unhealthy operation (e.g., NOT RUNNING or NOT IN COMPLIANCE). In this way, such automated techniques can be considered as pinpointing for the user or operator whichever specific services or containerized objects are operating unhealthily. Such automated techniques can eliminate any need for the user or operator to aimlessly or randomly call health statuses of the containerized objects and can thus consume far less time than existing containerization techniques.

More specifically, various embodiments described herein can be considered as a computerized tool (e.g., any suitable combination of computer-executable hardware or computer-executable software) that can facilitate composite and reboot-aware health checking of containerized applications. In various aspects, such a computerized tool can comprise an access component, a status component, or an execution component.

In various embodiments, there can be a containerized application hosted on a computing device. In various aspects, the containerized application can include a set of services. In various instances, each of the set of services can expose a respective plurality of containerized objects. Thus, the containerized application can be considered as comprising a set of pluralities of containerized objects. In various cases, each containerized object can be considered as having stored, maintained, recorded, or otherwise logged its last start time. In various aspects, the last start time of a containerized object can be the most recent time or date at which the containerized object was booted or started from scratch so as to have default settings, default state information, or a default configuration. Contrast such a boot-from-scratch with a prior state restoration that can instead involve restoring the containerized object to have some prior but non-default settings, some prior but non-default state information, or some prior but non-default configuration.

In various embodiments, there can be a user command. In various aspects, the user command can be any suitable electronic instruction that requests that a health of the containerized application be checked. In various instances, the user command can include any suitable credentials or certificates associated with a user or operator who created the user command.

In various embodiments, there can be a last reboot time. In various aspects, the last reboot time can be a most recent time or date at which the computing device that hosts the containerized application was rebooted (e.g., powered down and subsequently powered up).

In various embodiments, the access component of the computerized tool can electronically receive or otherwise access the containerized application, the user command, or the last reboot time. For example, the access component can retrieve the containerized application, the user command, or the last reboot time from any suitable centralized or decentralized data structure (e.g., graph data structure, relational data structure, hybrid data structure), whether remote from or local to the access component. In any case, the access component can obtain or access the containerized application, the user command, or the last reboot time, such that other components of the computerized tool can electronically interact with (e.g., initiate, execute, control, read, write, edit, copy, manipulate) the containerized application, the user command, or the last reboot time.

In various embodiments, the status component of the computerized tool can electronically generate a set of pluralities of object-level health statuses, in response to the user command and based on the last reboot time. More specifically, in response to the user command, the status component can iterate through each containerized object of the containerized application. For any given containerized object, the status component can perform a reboot-aware health check on that given containerized object. In various aspects, the reboot-aware health check can involve comparing the last start time of that given containerized object with the last reboot time of the computing device. If the last start time post-dates (e.g., is later than) the last reboot time, the status component can infer that the given containerized object has already been killed and started from scratch by the containerized application following the most recent reboot of the computing device. In other words, the status component can conclude that the containerized object is not stale (e.g., is not going to be suddenly killed and started from scratch by the containerized application). Thus, in such case, the status component can generate an object-level health status for the given containerized object by calling or querying the current health of the given containerized object. However, if the last start time pre-dates (e.g., is earlier than) the last reboot time, the status component can infer that the given containerized object has not yet been killed and started from scratch by the containerized application following the most recent reboot of the computing device. That is, the status component can conclude that the given containerized object is stale (e.g., is going to be suddenly killed and started from scratch by the containerized application). So, in such case, the status component can refrain from calling or querying the current health of the given containerized object (e.g., after all, such called or queried heath status would be suddenly rendered meaningless or inaccurate by the forthcoming kill-and-start). Instead, the status component can, in such case, assign to the given containerized object an object-level health status indicating unhealthy operation. In either case, the status component can obtain an object-level health status for the given containerized object. By performing such a reboot-aware health check for each containerized object in the set of pluralities of containerized objects, the status component can obtain a set of pluralities of object-level health statuses (e.g., one per containerized object of the containerized application).

In various embodiments, the status component can electronically generate a set of service-level health statuses, based on the set of pluralities of object-level health statuses. In particular, as mentioned above, each of the set of services can expose a respective plurality of containerized objects. Moreover, as mentioned above, the status component can have generated an object-level health status for each containerized object. So, the status component can, in various aspects, iterate through each service. For any given service, the status component can generate a service-level health status for that given service, based on the plurality of object-level health statuses that correspond to whichever plurality of containerized objects are exposed by that given service. If each of that plurality of object-level health statuses indicates healthy operation (e.g., if each containerized object exposed by the given service is determined to be operating properly), then the status component can assign to the given service a service-level health status indicating healthy operation. However, if at least one of that plurality of object-level health statuses indicates unhealthy operation (e.g., if one or more containerized objects exposed by the given service are determined to be operating improperly), then the status component can instead assign to the given service a service-level health status indicating unhealthy operation. In either case, the service-level health status assigned to that given service can be considered as being a composite or aggregated health status that is a function of the object-level health statuses of whichever containerized objects are exposed by that given service. In this way, the status component can obtain a set of service-level heath statuses (e.g., one per service of the containerized application).

In various embodiments, the status component can electronically generate an application-level health status, based on the set of service-level health statuses. In particular, if each of the set of service-level health statuses indicates healthy operation (e.g., if each service of the containerized application is determined to be operating properly), then the status component can assign to the containerized application an application-level health status indicating healthy operation. However, if at least one of the set of service-level health statuses indicates unhealthy operation (e.g., if one or more services of the containerized application are determined to be operating improperly), then the status component can assign to the containerized application an application-level health status indicating unhealthy operation. In either case, the application-level health status can be considered as being a composite or aggregated health status that is a function of the set of service-level health statuses and thus of the set of pluralities of object-level health statuses.

In various embodiments, the execution component of the computerized tool can electronically generate a health report, based on the application-level health status, based on the set of service-level health statuses, or based on the set of pluralities of object-level health statuses. In various aspects, the execution component can render the health report on any suitable electronic display (e.g., computer screen, computer monitor). In various instances, the execution component can transmit the health report to any other suitable electronic device. In any case, the health report can be any suitable electronic document or electronic message representing, indicating, or otherwise conveying health information pertaining to the containerized application. For example, the health report can include the application-level health status. Accordingly, a user or operator (or third-party client) that views the health report can quickly and easily become informed of whether or not the containerized application is operating properly, without having to wade through each object-level health status in an aimless, time-consuming fashion. As another example, the health report can include whichever of the set of service-level health statuses indicates unhealthy operation. Accordingly, a user or operator (or third-party client) that views the health report can quickly and easily become informed of which specific services of the containerized application, if any, are not operating properly, again without having to wade through each object-level health status in an aimless, time-consuming fashion. As yet another example, the health report can include whichever of the set of pluralities of object-level health statuses indicates unhealthy operation. Accordingly, a user or operator (or third-party client) that views the health report can quickly and easily become informed of which specific containerized objects of the containerized application, if any, are not operating properly, again without having to wade through each object-level health status in an aimless, time-consuming fashion.

Thus, the health report can, in some aspects, be considered as conveying to the user or operator composite, aggregated, overall, or summarized health of the containerized application, and the health report can, in other aspects, be considered as pinpointing for the user or operator which specific portions, if any, of the containerized application are malfunctioning. Contrast this with existing containerization techniques, which require the user or operator to manually call each containerized object's health in an aimless, random, or exhaustive fashion.

Additionally, because the health report can have been generated via reboot-aware health checks as described herein, the user or operator can have a higher degree of confidence that the health report does not include stale or inaccurate statuses. Contrast this with existing containerization techniques, which did not even recognize the health status staleness problem caused by console reboots.

In various other embodiments, the execution component can electronically schedule or otherwise recommend for maintenance to be performed on whichever containerized objects correspond to object-level health statuses indicating unhealthy operation.

In yet other embodiments, the execution component can electronically kill and start from scratch whichever containerized objects correspond to object-level health statuses indicating unhealthy operation. In this way, the execution component can be considered as attempting to cure whatever unhealthy operations have been detected.

Various embodiments described herein can be employed to use hardware or software to solve problems that are highly technical in nature (e.g., to facilitate composite and reboot-aware health checking of containerized applications), that are not abstract and that cannot be performed as a set of mental acts by a human. Further, some of the processes performed can be performed by a specialized computer (e.g., pods deployed by container orchestration platforms such as Kubernetes) for carrying out defined acts related to composite and reboot-aware health checking of containerized applications. For example, such defined acts can include: accessing, by a device operatively coupled to a processor, a containerized application, wherein the containerized application can include a set of services that respectively expose a set of pluralities of containerized objects; performing, by the device, in response to an electronic command, and for each containerized object in the set of pluralities of containerized objects, a respective reboot-aware health check, thereby yielding a set of pluralities of object-level health statuses; generating, by the device, an application-level health status based on the set of pluralities of object-level health statuses; and rendering, by the device, the application-level health status on an electronic display.

Such defined acts are not performed manually by humans. Indeed, neither the human mind nor a human with pen and paper can electronically access an instruction to evaluate the health of a containerized application (e.g., an application running on Kubernetes or Docker swarm) and electronically respond to such instruction by performing reboot-aware health checks on containerized objects (e.g., pods, manifests, cronjobs) of the containerized application. Indeed, a containerized application is an inherently-computerized construct that cannot be meaningfully implemented in any way by the human mind without computers. Moreover, containerized objects are specific, discrete resources defined within the containerized application that can perform any suitable software-related functionalities of the containerized application (e.g., pods can deploy containers or persistent volumes, manifests can specify desired states of pods, cronjobs can be specified operations that are to be periodically performed by pods). The human mind, even with the assistance of pen and paper, cannot reasonably be considered as implementing containerized objects of a containerized application. Furthermore, health checking is an inherently computerized process that involves querying containerized objects for their current health statuses. The human mind, even with the assistance of pen and paper, cannot in any meaningful way query a containerized object for its current health status. Accordingly, techniques that involve performing reboot-aware health checking for containerized applications are likewise inherently-computerized and cannot be implemented in any sensible, practical, or reasonable way without computers.

Moreover, various embodiments described herein can integrate into a practical application various teachings relating to composite and reboot-aware health checking for containerized applications. As explained above, existing containerization techniques support only individual or independent health status querying of containerized objects. Thus, if a user or operator desires to determine whether or not a containerized application is functioning properly via existing containerization techniques, the user or operator must call the health status of each containerized object one by one. Additionally, the user or operator can be considered as performing such one-by-one querying in an aimless or unguided manner. That is, existing containerization techniques do not provide any targeting or guidance regarding which specific containerized objects might be functioning improperly or should be checked first. Because the containerized application can have tens, hundreds, or even thousands of containerized objects, such one-by-one querying can be considered as an excessively tiresome, tedious, time-consuming process for the user or operator.

Furthermore, as mentioned above, the present inventors discovered that such existing containerization techniques are afflicted by a previously-unknown problem: health status staleness due to recent console rebooting. Indeed, the present inventors recognized that containerized applications can, in response to a console reboot, restore all of its containerized objects to whatever last known configuration or state information is available, and can shortly thereafter automatically kill and start from scratch all of its containerized objects. The present inventors realized that, if an existing containerization technique were used to obtain health statuses during the interim time period between the reboot and the kill-and-start, the obtained health statuses could be considered stale, unstable, or otherwise unreliable. After all, if a containerized object were restored post-reboot to a prior healthy operation and were instructed to perform some task during that interim time period, that task would likely be interrupted or prematurely terminated upon the subsequent kill-and-start of the containerized object, which could yield significant system errors. In other words, existing containerization techniques could return health statuses indicating healthy operation during that interim time period, but such health statuses cannot be relied upon or trusted due to the impending kill-and-start. It must emphasized that existing containerization techniques were not even aware of this problem.

Various embodiments described herein can address one or more of these technical problems. In particular, various embodiments described herein can involve automatically performing, in response to a user command, reboot-aware health checks on each containerized object of the containerized application. As described herein, a reboot-aware health check can involve calling the health status (whether it be healthy or unhealthy) of a containerized object if that containerized object was last started from scratch after the most recent console reboot (e.g., if that containerized object is not stale), and the reboot-aware health check can instead involve assigning to the containerized object a health status indicating unhealthy operation if that containerized object was last started from scratch before the most recent console reboot (e.g., if that containerized object is stale). Accordingly, such reboot-aware health checks can avoid situations in which stale containerized objects are misleadingly or unreliably determined to be operating healthily. In other words, when reboot-aware health checks are performed as described herein, situations can be avoided in which stale containerized objects are tasked with performing operations that will be suddenly terminated or interrupted by an impending kill-and-start. That is, various embodiments described herein can address the reboot staleness problem that afflicts existing containerization techniques.

Furthermore, various embodiments described herein can involve combining or aggregating object-level health statuses that have been measured in reboot-aware fashion into service-level health statuses. Moreover, various embodiments described herein can involve combining or aggregating service-level health statuses into an application-level health status. In other words, various embodiments described herein can involve generating composite, high-level health statuses from more granular, low-level health statuses. In this way, a user or operator can be summarily informed about an overall health of a service or of the containerized application, without having to tediously, aimlessly, and time-consumingly call a health status from each containerized object.

For at least these reasons, various embodiments described herein certainly constitute concrete and tangible technical improvements in the field of containerized applications, and such embodiments therefore clearly qualify as useful and practical applications of computers.

It should be appreciated that the herein figures and description provide non-limiting examples of various embodiments and are not necessarily drawn to scale.

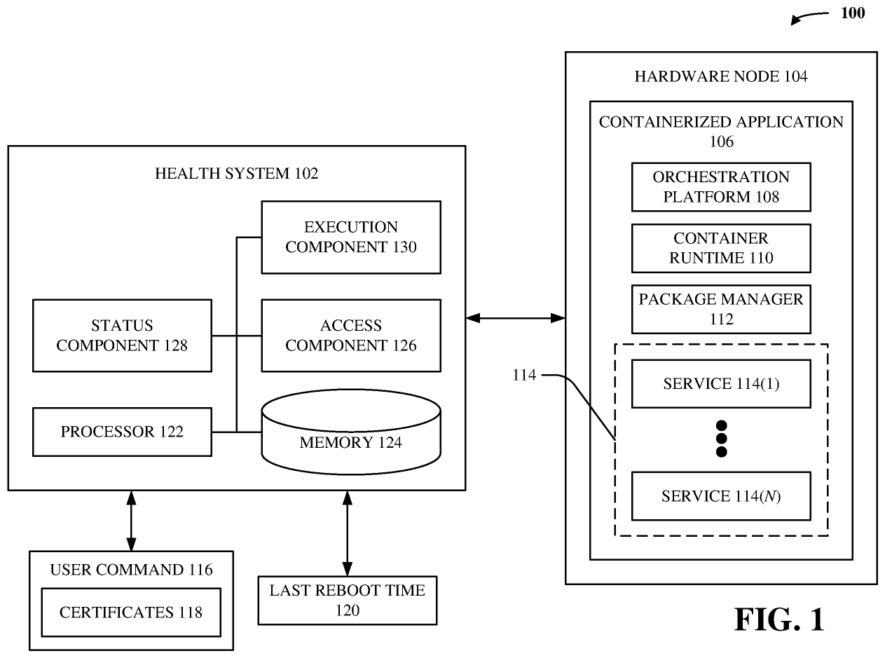

FIG. 1 illustrates a block diagram of an example, non-limiting system 100 that can facilitate composite and reboot-aware health checking of containerized applications in accordance with one or more embodiments described herein. As shown, a health system 102 can be electronically integrated, via any suitable wired or wireless electronic connections, with a hardware node 104, with a user command 116, or with a last reboot time 120.

In various embodiments, the hardware node 104 can be any suitable computing device which can comprise any suitable number of processors (e.g., computer processing units, microprocessors) and any suitable number of non-transitory computer-readable memories (e.g., hard disk drives, solid state drives). As a non-limiting example, the hardware node 104 can be a desktop computer. As another non-limiting example, the hardware node 104 can be a laptop computer. As yet another non-limiting example, the hardware node 104 can be a smart phone. As even another non-limiting example, the hardware node 104 can be a vehicle-integrated computer. As still another non-limiting example, the hardware node 104 can be a medical imaging scanner, such as a CT scanner, an MRI scanner, an X-ray scanner, a PET scanner, or an ultrasound scanner.

In various embodiments, the hardware node 104 can host a containerized application 106. In various aspects, the containerized application 106 can be any suitable computer program that can be implemented or organized in containerized fashion. As a non-limiting example, the containerized application 106 can be a medical imaging program, a medical diagnostic program, or a medical prognostic program in situations where the hardware node 104 is a medical imaging scanner. As another non-limiting example, the containerized application 106 can be a self-driving program, an engine monitoring program, or a traffic monitoring program in situations where the hardware node 104 is a vehicle-integrated computer. In various instances, the containerized application 106 can be implemented, organized, or otherwise facilitated by an orchestration platform 108. In various cases, the orchestration platform 108 can be any suitable container orchestration software. As a non-limiting example, the orchestration platform 108 can be Kubernetes. As another non-limiting example, the orchestration platform 108 can be Docker swarm. Furthermore, in various aspects, the containerized application 106 can be implemented, organized, or otherwise facilitated by a container runtime 110. In various instances, the container runtime 110 can be any suitable container runtime software. As a non-limiting example, the container runtime 110 can be Docker. As another non-limiting example, the container runtime 110 can be runC. As yet another non-limiting example, the container runtime 110 can be containerd. As still another non-limiting example, the container runtime 110 can be Windows Containers. Further still, in various cases, the containerized application 106 can be implemented, organized, or otherwise facilitated by a package manager 112. In various aspects, the package manager 112 can be any suitable package management software. As a non-limiting example, the package manager 112 can be Helm.

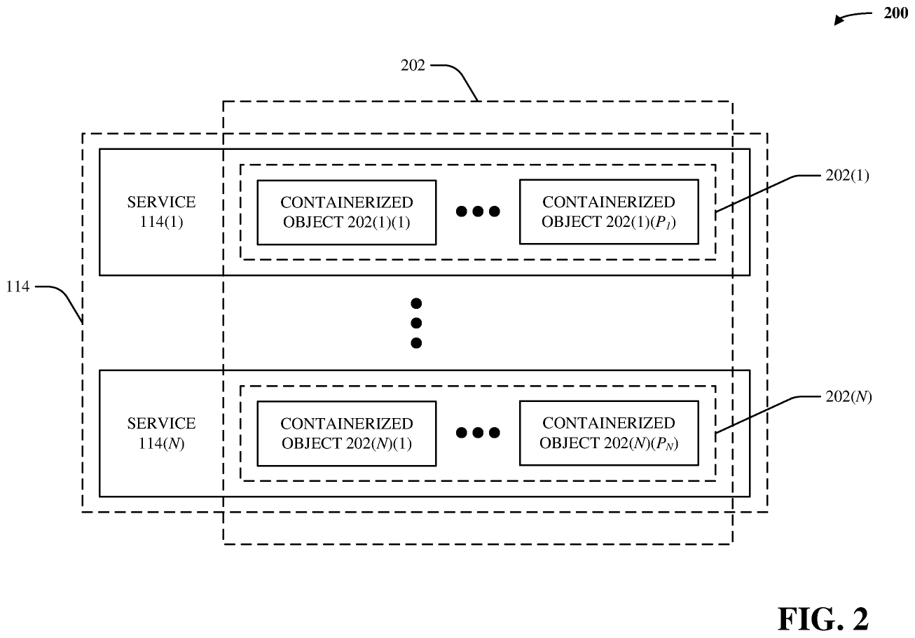

In various aspects, the containerized application 106 can comprise a set of services 114. In various instances, the set of services 114 can comprise n services for any suitable positive integer n: a service 114(1) to a service 114(n). In various cases, a service can be considered as a logical wrapper that can expose any suitable number of containerized objects to other services or to front-end clients. As a non-limiting example, the service 114(1) can be a logical wrapper that exposes a first collection of any suitable containerized objects. As another non-limiting example, the service 114(n) can be a logical wrapper for an n-th collection of any suitable containerized objects. In various aspects, different ones of the set of services 114 can expose the same or different types or the same or different numbers of containerized objects as each other. Various non-limiting details are explained with respect to FIG. 2.

FIG. 2 illustrates an example, non-limiting block diagram 200 showing services exposing containerized objects in accordance with one or more embodiments described herein. That is, FIG. 2 depicts an example, non-limiting embodiment of the set of services 114.

In various aspects, as shown, the service 114(1) can expose a plurality of containerized objects 202(1). In various instances, the plurality of containerized objects 202(1) can comprise p₁ objects for any suitable positive integer p₁≥2: a containerized object 202(1)(1) to a containerized object 202(1)(p₁). Similarly, as shown, the service 114(n) can expose a plurality of containerized objects 202(n). In various cases, the plurality of containerized objects 202(n) can comprise pₙ objects for any suitable positive integer pₙ≥2: a containerized object 202(n)(1) to a containerized object 202(n)(pₙ). In various aspects, the plurality of containerized objects 202(1) to the plurality of containerized objects 202(n) can be collectively considered or otherwise referred to as a set of pluralities of containerized objects 202.

In any case, a containerized object can be considered as any suitable discrete or defined software resource within the containerized application 106. As a non-limiting example, a containerized object can be a pod of the containerized application 106, where a pod can be considered as a logical wrapper that can deploy one or more containers or one or more persistent volumes. As another non-limiting example, a containerized object can be a manifest of the containerized application, where a manifest can specify desired states to be achieved by one or more other containerized objects. For instance, a manifest can be a deployment, a stateful set, a replica set, or a daemon set. As yet another non-limiting example, a containerized object can be a job or cronjob that is to be implemented or performed, periodically or in ad hoc fashion, by one or more other containerized objects. As even another non-limiting example, a containerized object can be a custom defined resource (crd).

Although not explicitly shown in FIG. 2, each containerized object in the set of pluralities of containerized objects 202 can electronically store, electronically record, or otherwise electronically log a respective last start time. In various aspects, a last start time of a particular containerized object can be any suitable electronic data indicating, conveying, or otherwise representing when that particular containerized object was most recently started from scratch according to default configuration or state information (not when that particular containerized object was most recently restored to prior non-default configuration or state information). In some instances, the last start time can be a timestamp indicating a specific time or date at which the most recent start-from-scratch of the particular containerized object occurred. As a non-limiting example, the last start time can indicate a year, month, day, hour, minute, second, or fraction of a second at which such most recent start-from-scratch of the particular containerized object transpired. In other instances, however, the last start time can instead be a total amount of time that has elapsed since the most recent start-from-scratch of the particular containerized object occurred. As a non-limiting example, the last start time can be one or more scalars indicating how many years, months, days, hours, minutes, seconds, or fractions of a second have passed since the most recent start-from-scratch of the particular containerized object transpired.

Referring back to FIG. 1, the user command 116 can be any suitable electronic instruction that requests health information pertaining to the containerized application 106. In various aspects, the user command 116 can be generated or created by a user, operator, or technician that desires to determine whether or not the containerized application 106 should undergo maintenance. As a non-limiting example, such user, operator, or technician can create the user command 116 via any suitable human-to-computer interface device, such as a keyboard, a keypad, a touchscreen, or a computer mouse. In various other aspects, the user command 116 can be generated or created by a third-party computing device (not shown) that is attempting to determine whether or not the containerized application 106 is able to handle a computing task. In some cases, the third-party computing device can be considered as a front-end computing client. In various instances, the user command 116 can have or otherwise be associated with one or more certificates 118. In various cases, the one or more certificates 118 can be considered as security or licensing credentials (e.g., username, password, authorization identifier) associated with whatever entity created or generated the user command 116.

In various aspects, the last reboot time 120 can be any suitable electronic data indicating, conveying, or otherwise representing when the hardware node 104 was most recently rebooted. In some instances, the last reboot time 120 can be a timestamp indicating a specific time or date at which the most recent reboot of the hardware node 104 occurred (e.g., the last reboot time 120 can indicate a year, month, day, hour, minute, second, or fraction of a second at which such most recent reboot of the hardware node 104 transpired). In other instances, however, the last reboot time 120 can instead be a total amount of time that has elapsed since the most recent reboot of the hardware node 104 occurred (e.g., the last reboot time 120 can be one or more scalars indicating how many years, months, days, hours, minutes, seconds, or fractions of a second have passed since the most recent reboot of the hardware node 104 transpired).

In various aspects, as described herein, the health system 102 can respond to the user command 116 by evaluating health information of the containerized application 106 based on the last reboot time 120.

In various embodiments, the health system 102 can comprise a processor 122 (e.g., computer processing unit, microprocessor) and a non-transitory computer-readable memory 124 that is operably connected or coupled to the processor 122. The memory 124 can store computer-executable instructions which, upon execution by the processor 122, can cause the processor 122 or other components of the health system 102 (e.g., access component 126, status component 128, execution component 130) to perform one or more acts. In various embodiments, the memory 124 can store computer-executable components (e.g., access component 126, status component 128, execution component 130), and the processor 122 can execute the computer-executable components.

In various embodiments, the health system 102 can comprise an access component 126. In various aspects, the access component 126 can electronically receive or otherwise electronically access the containerized application 106, the user command 116, or the last reboot time 120. As a non-limiting example, the access component 126 can electronically retrieve, obtain, or import, from the hardware node 104, the containerized application 106 or the last reboot time 120. As another non-limiting example, the access component 126 can electronically retrieve, obtain, or import, from any suitable data structure or computing device, the user command 116. In any case, the access component 126 can electronically access the containerized application 106, the user command 116, or the last reboot time 120, such that other components of the health system 102 can electronically interact with or otherwise electronically control the containerized application 106, the user command 116, or the last reboot time 120.

In various aspects, the access component 126 can electronically validate or otherwise verify the user command 116. In some instances, such validation or verification can be based on the one or more certificates 118. As a non-limiting example, the access component 126 can electronically check that the one or more certificates 118 are valid or otherwise unexpired (e.g., by cross referencing the one or more certificates 118 against a set of certificates that are known or deemed to be valid or unexpired, or by cross referencing the one or more certificates 118 against a set of certificates that are known or deemed to be invalid or expired). If the one or more certificates 118 are invalid or expired, the access component 126 can determine that the user, operator, or client that created the user command 116 lacks permission or authorization to request health information of the containerized application 106. In such case, the access component 126 can discard or delete the user command 116. However, if the one or more certificates 118 are instead valid or unexpired, the access component 126 can determine that the user, operator, or client that created the user command 116 has permission or authorization to request health information of the containerized application 106. In such case, the health system 102 can provide such health information, as described herein.

In various embodiments, the health system 102 can comprise a status component 128. In various aspects, as described herein, the status component 128 can electronically generate a set of pluralities of object-level health statuses, by performing reboot-aware health checks on the set of pluralities of containerized objects 202. In various instances, as described herein, the status component 128 can aggregate the set of pluralities of object-level health statuses into a set of service-level health statuses respectively corresponding to the set of services 114. In various cases, as described herein, the status component 128 can further aggregate the set of service-level health statuses into an application-level health status for the containerized application 106.

In various embodiments, the health system 102 can comprise an execution component 130. In various aspects, as described herein, the execution component 130 can electronically generate a health report, based on the health statuses generated by the status component 128. In various instances, as described herein, the execution component 130 can electronically schedule or otherwise request maintenance to be performed on the containerized application 106, based on the health statuses generated by the status component 128.

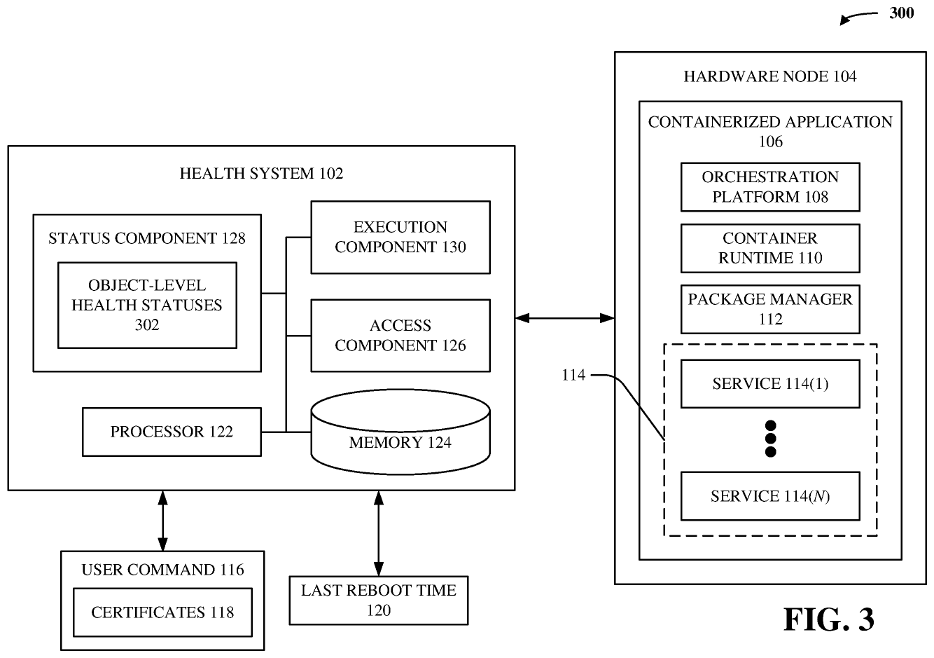

FIG. 3 illustrates a block diagram of an example, non-limiting system 300 including a set of object-level health statuses that can facilitate composite and reboot-aware health checking of containerized applications in accordance with one or more embodiments described herein. As shown, the system 300 can, in some cases, comprise the same components as the system 100, and can further comprise a set of pluralities of object-level health statuses 302.

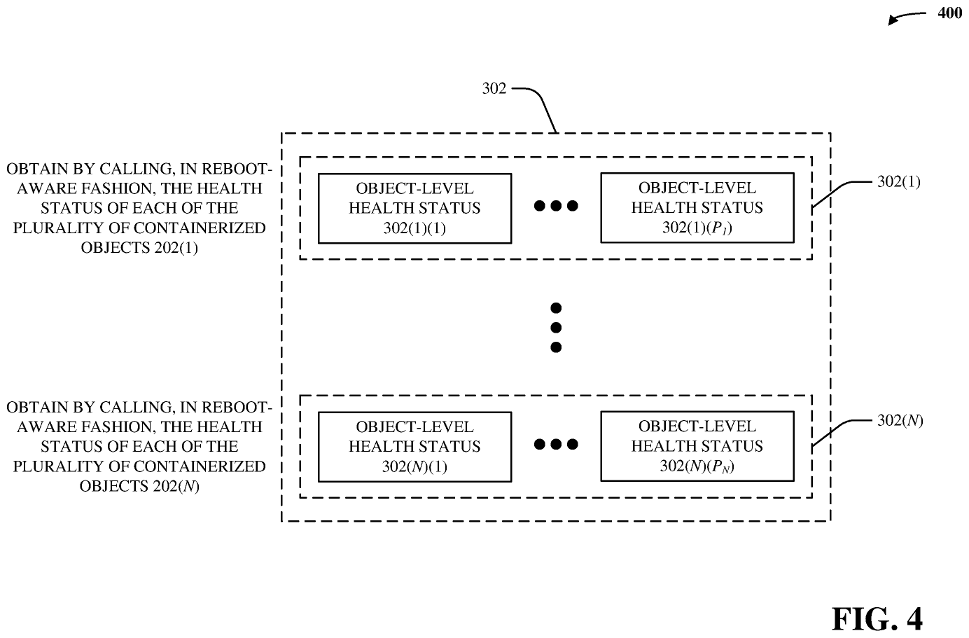

In various embodiments, the status component 128 can, in response to the access component 126 determining that the one or more certificates 118 are valid or unexpired, electronically generate the set of pluralities of object-level health statuses 302, by performing reboot-aware health checks on each of the set of pluralities of containerized objects 202. In various instances, an object-level health status can be any suitable electronic data exhibiting any suitable format, size, or dimensionality (e.g., can be one or more scalars, one or more vectors, one or more matrices, one or more tensors, one or more character strings, or any suitable combination thereof) that can indicate or otherwise represent a health of a respective containerized object. In some cases, an object-level health status can be a dichotomous variable that can indicate one of two possible operating modes of a respective containerized object: healthy operation (e.g., OBJECT RUNNING, or OBJECT IN COMPLIANCE); or unhealthy operation (e.g., OBJECT NOT RUNNING, or OBJECT NOT IN COMPLIANCE). However, this is a mere non-limiting example for ease of explanation. In other cases, an object-level health status can be a multichotomous variable that can indicate one of three or more possible operating modes. In any case, the status component 128 can generate the set of pluralities of object-level health statuses 302 by performing reboot-aware health checks on the set of pluralities of containerized objects 202. Non-limiting aspects are described with respect to FIG. 4.

FIG. 4 illustrates an example, non-limiting block diagram 400 showing the set of pluralities of object-level health statuses 302 in accordance with one or more embodiments described herein.

In various aspects, as mentioned above, the access component 126 can conclude that the one or more certificates 118 are valid or unexpired. In response to such determination, the status component 128 can iterate through each of the set of services 114. For any given service, the status component 128 can generate, in reboot-aware fashion, an object-level health status for each containerized object exposed by that given service.

As a non-limiting example, the status component 128 can iterate to or otherwise consider the service 114(1). As mentioned above, the service 114(1) can expose the plurality of containerized objects 202(1). In various aspects, the status component 128 can perform a reboot-aware health check on each of the plurality of containerized objects 202(1). For any given containerized object, a reboot-aware health check can involve: generating an object-level health status for that given containerized object by calling or querying its current health, if the last start time of that given containerized object post-dates the last reboot time 120; or assigning to that given containerized object an object-level health status indicating unhealthy operation, if the last start time of that given containerized object pre-dates the last reboot time 120.

For instance, the status component 128 can perform a reboot-aware health check on the containerized object 202(1)(1), and such reboot-aware health check can yield an object-level health status 302(1)(1). In various aspects, it can be the case that the last start time of the containerized object 202(1)(1) post-dates the last reboot time 120 (e.g., it can be the case that the containerized object 202(1)(1) was most recently started from scratch after the most recent reboot of the hardware node 104). In such case, the status component 128 can conclude or determine that the containerized object 202(1)(1) is not stale (e.g., is not going to suddenly be interrupted or terminated by an impending kill-and-start). Accordingly, the status component 128 can call or query the current health of the containerized object 202(1)(1), and the object-level health status 302(1)(1) can be the result of such calling or querying. Thus, the object-level health status 302(1)(1) can indicate healthy operation or unhealthy operation (or any other defined mode of operation in multichotomous settings). On the other hand, it can instead be the case that the last start time of the containerized object 202(1)(1) pre-dates the last reboot time 120 (e.g., it can instead be the case that the containerized object 202(1)(1) was most recently started from scratch prior to the most recent reboot of the hardware node 104). In such case, the status component 128 can conclude or determine that the containerized object 202(1)(1) is stale (e.g., is going to suddenly be interrupted or terminated by an impending kill-and-start). So, the status component 128 can refrain from calling or querying the containerized object 202(1)(1) for its current health. Instead, the status component 128 can cause the object-level health status 302(1)(1) to indicate unhealthy operation, regardless of what the containerized object 202(1)(1) would report its current health to be.

In another instance, the status component 128 can perform a reboot-aware health check on the containerized object 202(1)(p₁), and such reboot-aware health check can yield an object-level health status 302(1)(p₁). In various aspects, it can be the case that the last start time of the containerized object 202(1)(p₁) post-dates the last reboot time 120 (e.g., it can be the case that the containerized object 202(1)(p₁) was most recently started from scratch after the most recent reboot of the hardware node 104). In such case, the status component 128 can conclude or determine that the containerized object 202(1)(p₁) is not stale (e.g., is not going to suddenly be interrupted or terminated by an impending kill-and-start). Accordingly, the status component 128 can call or query the current health of the containerized object 202(1)(p₁), and the object-level health status 302(1)(p₁) can be the result of such calling or querying. Thus, the object-level health status 302(1)(p₁) can indicate healthy operation or unhealthy operation (or any other defined mode of operation, as appropriate). In contrast, it can instead be the case that the last start time of the containerized object 202(1)(p₁) pre-dates the last reboot time 120 (e.g., it can instead be the case that the containerized object 202(1)(p₁) was most recently started from scratch prior to the most recent reboot of the hardware node 104). In such case, the status component 128 can conclude or determine that the containerized object 202(1)(p₁) is stale (e.g., is going to suddenly be interrupted or terminated by an impending kill-and-start). So, the status component 128 can refrain from calling or querying the containerized object 202(1)(p₁) for its current health. Instead, the status component 128 can cause the object-level health status 302(1)(p₁) to indicate unhealthy operation, regardless of what the containerized object 202(1)(p₁) would report its current health to be.

In various aspects, the object-level health status 302(1)(1) to the object-level health status 302(1)(p₁) can collectively be referred to as a plurality of object-level health statuses 302(1). In other words, the plurality of object-level health statuses 302(1) can be considered as being the health statuses of whichever containerized objects are exposed by the service 114(1).

As another non-limiting example, the status component 128 can iterate to or otherwise consider the service 114(n). As mentioned above, the service 114(n) can expose the plurality of containerized objects 202(n). In various aspects, the status component 128 can perform a reboot-aware health check on each of the plurality of containerized objects 202(n). Just as above, for any given containerized object, a reboot-aware health check can involve: generating an object-level health status for that given containerized object by calling or querying its current health, if the last start time of that given containerized object post-dates the last reboot time 120; or assigning to that given containerized object an object-level health status indicating unhealthy operation, if the last start time of that given containerized object pre-dates the last reboot time 120.

For instance, the status component 128 can perform a reboot-aware health check on the containerized object 202(n)(1), and such reboot-aware health check can yield an object-level health status 302(n)(1). In various aspects, it can be the case that the last start time of the containerized object 202(n)(1) post-dates the last reboot time 120 (e.g., it can be the case that the containerized object 202(n)(1) was most recently started from scratch after the most recent reboot of the hardware node 104). In such case, the status component 128 can conclude or determine that the containerized object 202(n)(1) is not stale (e.g., is not going to suddenly be interrupted or terminated by an impending kill-and-start). Accordingly, the status component 128 can call or query the current health of the containerized object 202(n)(1), and the object-level health status 302(n)(1) can be the result of such calling or querying. Therefore, the object-level health status 302(n)(1) can indicate healthy operation or unhealthy operation (or any other defined mode of operation, as appropriate). However, on the other hand, it can instead be the case that the last start time of the containerized object 202(n)(1) pre-dates the last reboot time 120 (e.g., it can instead be the case that the containerized object 202(n)(1) was most recently started from scratch prior to the most recent reboot of the hardware node 104). In such case, the status component 128 can conclude or determine that the containerized object 202(n)(1) is stale (e.g., is going to suddenly be interrupted or terminated by an impending kill-and-start). So, the status component 128 can refrain from calling or querying the containerized object 202(n)(1) for its current health. Instead, the status component 128 can cause the object-level health status 302(n)(1) to indicate unhealthy operation, regardless of what the containerized object 202(n)(1) would report its current health to be.

In another instance, the status component 128 can perform a reboot-aware health check on the containerized object 202(n)(pₙ), and such reboot-aware health check can yield an object-level health status 302(n)(pₙ). In various aspects, it can be the case that the last start time of the containerized object 202(n)(pₙ) post-dates the last reboot time 120 (e.g., it can be the case that the containerized object 202(n)(pₙ) was most recently started from scratch after the most recent reboot of the hardware node 104). In such case, the status component 128 can conclude or determine that the containerized object 202(n)(pₙ) is not stale (e.g., is not going to suddenly be interrupted or terminated by an impending kill-and-start). Accordingly, the status component 128 can call or query the current health of the containerized object 202(n)(pₙ), and the object-level health status 302(n)(pₙ) can be the result of such calling or querying. Thus, the object-level health status 302(n)(pₙ) can indicate healthy operation or unhealthy operation (or any other defined mode of operation, as appropriate). In contrast, it can instead be the case that the last start time of the containerized object 202(n)(pₙ) pre-dates the last reboot time 120 (e.g., it can instead be the case that the containerized object 202(n)(pₙ) was most recently started from scratch prior to the most recent reboot of the hardware node 104). In such case, the status component 128 can conclude or determine that the containerized object 202(n)(pₙ) is stale (e.g., is going to suddenly be interrupted or terminated by an impending kill-and-start). So, the status component 128 can refrain from calling or querying the containerized object 202(n) (pₙ) for its current health. Instead, the status component 128 can cause the object-level health status 302(n)(pₙ) to indicate unhealthy operation, regardless of what the containerized object 202(n) (pₙ) would report its current health to be.

In various aspects, the object-level health status 302(n)(1) to the object-level health status 302(n)(pₙ) can collectively be referred to as a plurality of object-level health statuses 302(n). That is, the plurality of object-level health statuses 302(n) can be considered as being the health statuses of whichever containerized objects are exposed by the service 114(n).

In various instances, the plurality of object-level health statuses 302(1) to the plurality of object-level health statuses 302(n) can collectively be considered as the set of pluralities of object-level health statuses 302.

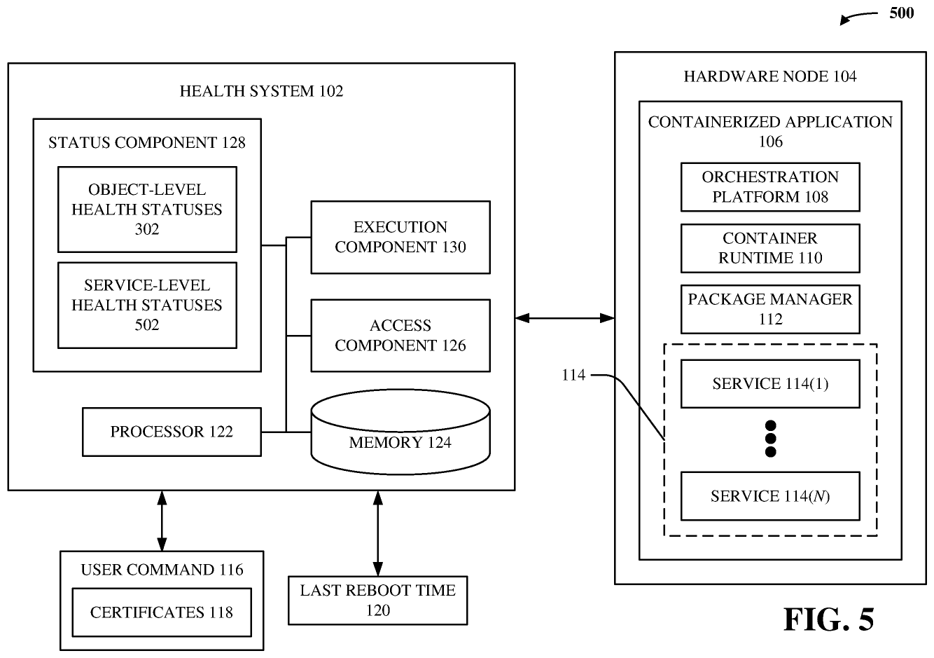

FIG. 5 illustrates a block diagram of an example, non-limiting system 500 including a set of service-level health statuses that can facilitate composite and reboot-aware health checking of containerized applications in accordance with one or more embodiments described herein. As shown, the system 500 can, in some cases, comprise the same components as the system 300, and can further comprise a set of service-level health statuses 502.

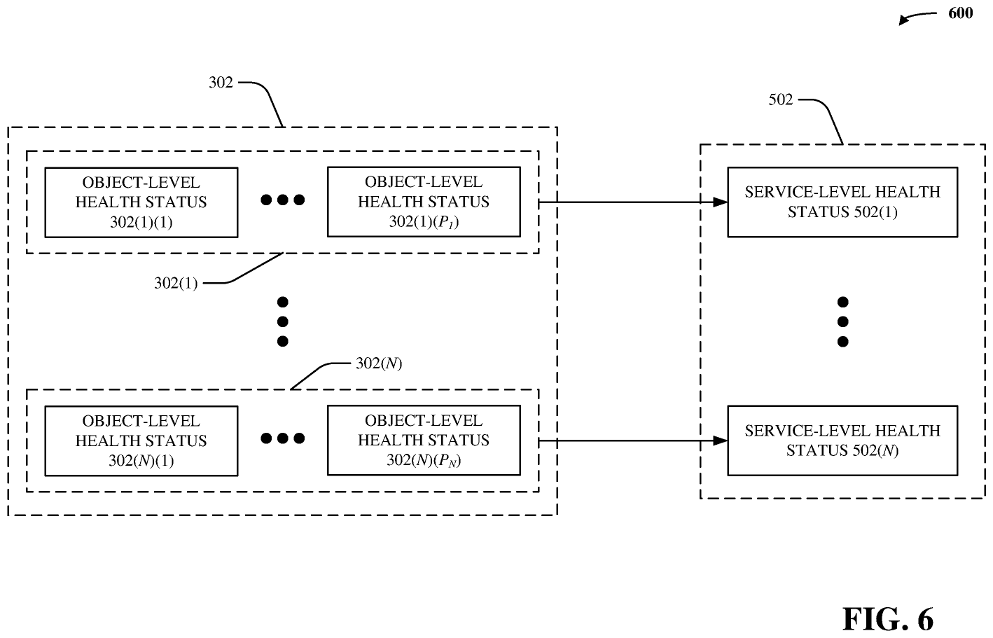

In various embodiments, the status component 128 can electronically generate the set of service-level health statuses 502, based on the set of pluralities of object-level health statuses 302. In various instances, a service-level health status can have the same format, size, or dimensionality as an object-level health status. However, rather than indicating the health of a respective containerized object, a service-level health status can instead indicate or represent the health of a respective service. Accordingly, in some cases, a service-level health status can be a dichotomous variable that can indicate one of two possible operating modes of a respective service: healthy operation (e.g., SERVICE RUNNING, or SERVICE IN COMPLIANCE); or unhealthy operation (e.g., SERVICE NOT RUNNING, or SERVICE NOT IN COMPLIANCE). However, this is a mere non-limiting example for ease of explanation. In other cases, a service-level health status can be a multichotomous variable that can indicate one of three or more possible operating modes. In any case, the status component 128 can generate the set of service-level health statuses 502 based on the set of pluralities of object-level health statuses 302. Non-limiting aspects are described with respect to FIG. 6.

FIG. 6 illustrates an example, non-limiting block diagram 600 showing how the set of service-level health statuses 502 can be obtained from the set of pluralities of object-level health statuses 302 in accordance with one or more embodiments described herein.

In various aspects, as mentioned above, the service 114(1) can expose the plurality of containerized objects 202(1), and the plurality of object-level health statuses 302(1) can indicate the respective healths of the plurality of containerized objects 202(1). In various instances, the status component 128 can generate a service-level health status 502(1) based on the plurality of object-level health statuses 302(1), where the service-level health status 502(1) can be considered as indicating, representing, or summarizing the overall or collective health of the service 114(1). As a non-limiting example, the status component 128 can determine whether each of the plurality of object-level health statuses 302(1) indicates healthy operation. If so (e.g., if each containerized object exposed by the service 114(1) is determined to be operating properly), then the status component 128 can cause the service-level health status 502(1) to indicate healthy operation. If not (e.g., if at least one containerized object exposed by the service 114(1) is determined to be operating improperly), then the status component 128 can cause the service-level health status 502(1) to indicate unhealthy operation. Thus, the service-level health status 502(1) can be considered as a composite or aggregated status that summarily indicates the overall or total health of the service 114(1). In other words, the service-level health status 502(1) can enable a user, operator, or client to become apprised of the overall health of the service 114(1) without having to individually consider each of the plurality of object-level health statuses 302(1).

Likewise, as mentioned above, the service 114(n) can expose the plurality of containerized objects 202(n), and the plurality of object-level health statuses 302(n) can indicate the respective healths of the plurality of containerized objects 202(n). In various instances, the status component 128 can generate a service-level health status 502(n) based on the plurality of object-level health statuses 302(n), where the service-level health status 502(n) can be considered as indicating, representing, or summarizing the overall or collective health of the service 114(n). As a non-limiting example, the status component 128 can determine whether each of the plurality of object-level health statuses 302(n) indicates healthy operation. If so (e.g., if each containerized object exposed by the service 114(n) is determined to be operating properly), then the status component 128 can cause the service-level health status 502(n) to indicate healthy operation. If not (e.g., if at least one containerized object exposed by the service 114(n) is determined to be operating improperly), then the status component 128 can cause the service-level health status 502(n) to indicate unhealthy operation. So, the service-level health status 502(n) can be considered as a composite or aggregated status that summarily indicates the overall or total health of the service 114(n). That is, the service-level health status 502(n) can enable a user, operator, or client to become apprised of the overall health of the service 114(n) without having to individually consider each of the plurality of object-level health statuses 302(n).

In various cases, the service-level health status 502(1) to the service-level health status 502(n) can collectively be considered as the set of service-level health statuses 502.

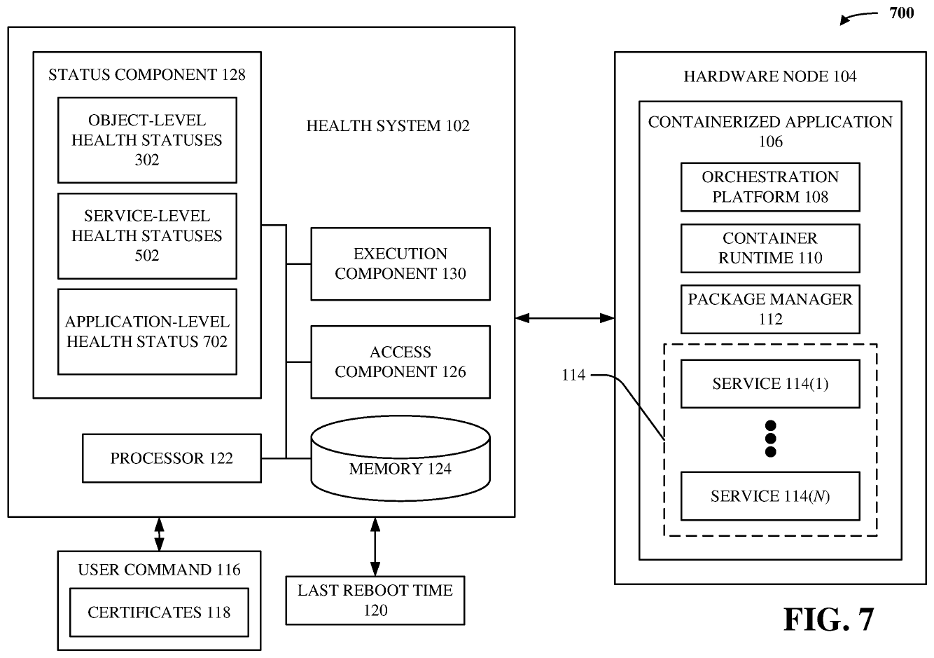

FIG. 7 illustrates a block diagram of an example, non-limiting system 700 including an application-level health status that can facilitate composite and reboot-aware health checking of containerized applications in accordance with one or more embodiments described herein. As shown, the system 700 can, in some cases, comprise the same components as the system 500, and can further comprise an application-level health status 702.

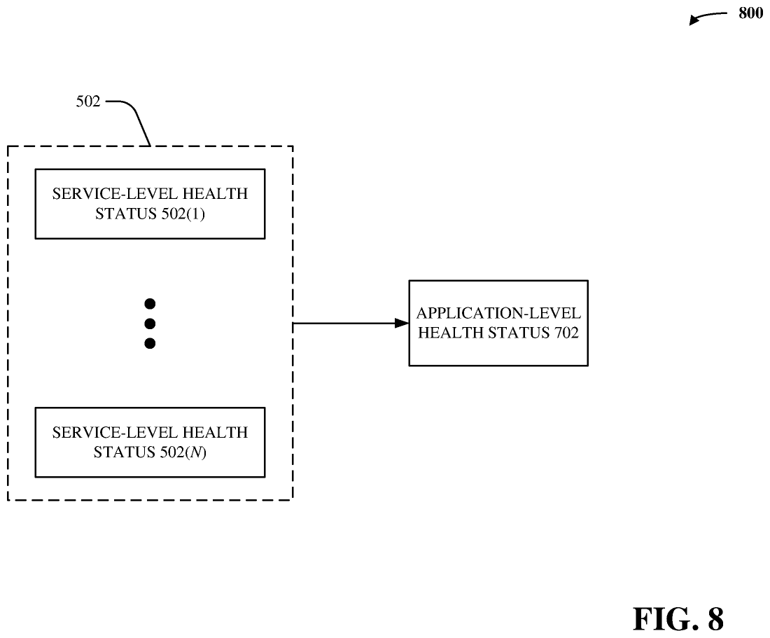

In various embodiments, the status component 128 can electronically generate the application-level health status 702, based on the set of service-level health statuses 502. In various instances, the application-level health status 702 can have the same format, size, or dimensionality as a service-level health status or as an object-level health status. However, rather than indicating the health of a respective containerized object or a respective service, the application-level health status 702 can instead indicate or represent the overall or total health of the containerized application 106. Accordingly, in some cases, the application-level health status 702 can be a dichotomous variable that can indicate one of two possible operating modes of the containerized application 106: healthy operation (e.g., APP RUNNING, or APP IN COMPLIANCE); or unhealthy operation (e.g., APP NOT RUNNING, or APP NOT IN COMPLIANCE). However, this is a mere non-limiting example for case of explanation. In other cases, the application-level health status 702 can be a multichotomous variable that can indicate one of three or more possible operating modes. In any case, the status component 128 can generate the application-level health status 702 based on the set of service-level health statuses 502. Non-limiting aspects are described with respect to FIG. 8.

FIG. 8 illustrates an example, non-limiting block diagram 800 showing how the application-level health status 702 can be obtained from the set of service level health statuses 502 in accordance with one or more embodiments described herein.

In various aspects, as mentioned above, the containerized application 106 can comprise the set of services 114, and the set of service-level health statuses 502 can indicate the respective healths of the set of services 114. In various instances, the status component 128 can generate the application-level health status 702 based on the set of service-level health statuses 502. As a non-limiting example, the status component 128 can determine whether each of the set of service-level health statuses 502 indicates healthy operation. If so (e.g., if each service of the containerized application 106 is determined to be operating properly), then the status component 128 can cause the application-level health status 702 to indicate healthy operation. If not (e.g., if at least one service of the containerized application 106 is determined to be operating improperly), then the status component 128 can cause the application-level health status 702 to indicate unhealthy operation. Thus, the application-level health status 702 can be considered as a composite or aggregated status that summarily indicates the overall or total health of the containerized application 106. In other words, the application-level health status 702 can enable a user, operator, or client to become apprised of the overall health of the containerized application 106 without having to individually consider each of the set of service-level health statuses 502 or each of the set of pluralities of object-level health statuses 302.

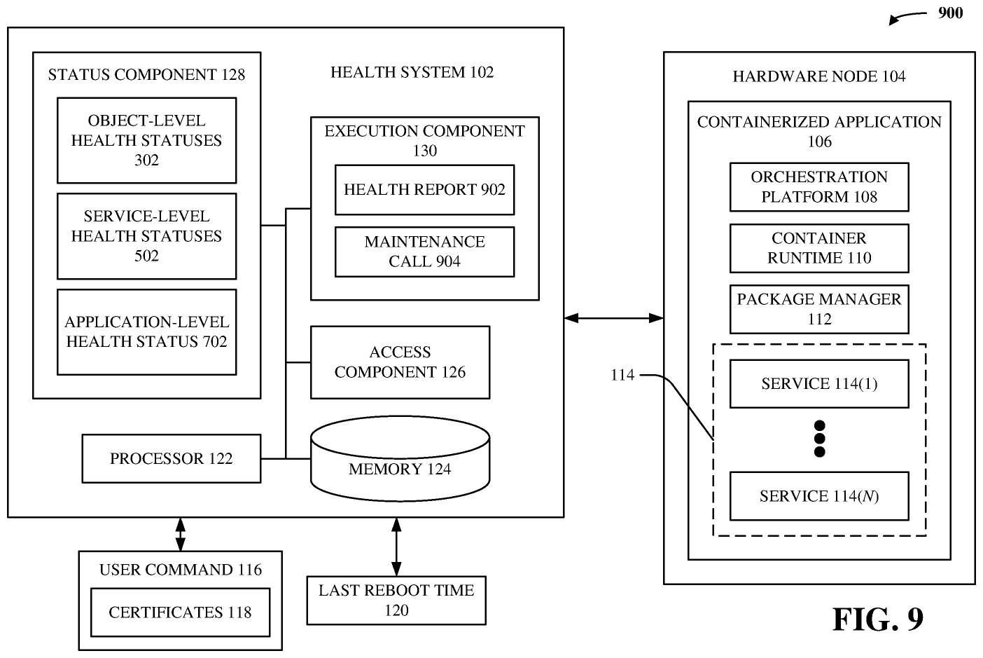

FIG. 9 illustrates a block diagram of an example, non-limiting system 900 including a health report and a maintenance call that can facilitate composite and reboot-aware health checking of containerized applications in accordance with one or more embodiments described herein. As shown, the system 900 can, in some cases, comprise the same components as the system 700, and can further comprise a health report 902 or a maintenance call 904.

In various aspects, the execution component 130 can electronically generate a health report 902, based on the set of pluralities of object-level health statuses 302, based on the set of service-level health statuses 502, or based on the application-level health status 702. In some instances, the execution component 130 can render the health report on any suitable electronic display, such as a computer screen or computer monitor. In other instances, the execution component 130 can transmit the health report to any other suitable computing device (not shown). In any case, the health report 902 can be any suitable electronic message or electronic document that summarizes or otherwise indicates health information pertaining to the containerized application 106.

As a non-limiting example, the health report 902 can include or otherwise indicate the application-level health status 702. Thus, a user, operator, or client that reads or views the health report 902 can be apprised of the overall health of the containerized application 106 (e.g., APP RUNNING, or APP NOT RUNNING) without having to time-consumingly consider each of the set of pluralities of object-level health statuses 302 or each of the set of service-level health statuses 502.

As another non-limiting example, the health report 902 can include or otherwise indicate whichever of the set of service-level health statuses 502 that specify unhealthy operation. Thus, a user, operator, or client that reads or views the health report 902 can be apprised of which specific services, if any, of the containerized application 106 are not operating properly, without having to time-consumingly consider each of the set of pluralities of object-level health statuses 302 or each of the set of service-level health statuses 502.

As yet another non-limiting example, the health report 902 can include or otherwise indicate whichever of the set of pluralities of object-level health statuses 302 that specify unhealthy operation. Thus, a user, operator, or client that reads or views the health report 902 can be apprised of which specific containerized objects, if any, of the containerized application 106 are not operating properly, without having to time-consumingly consider each of the set of pluralities of object-level health statuses 302.

Thus, generation of the health report 902 can be considered as saving time and effort for such user, operator, or client.

Moreover, because the health report 902 can have been generated via reboot-aware health checking as described herein, such user, operator, or client can have confidence that the health report 902 is accurate, reliable, or otherwise not stale.

In some cases, the health report 902 can include any other suitable information pertaining to the containerized application 106. As a non-limiting example, the execution component 130 can call or query the containerized application 106 for a version identifier or health status of the orchestration platform 108, and the health report 902 can include such version identifier or health status. As another non-limiting example, the execution component 130 can call or query the containerized application 106 for a version identifier or health status of the container runtime 110, and the health report 902 can include such version identifier or health status. As still another non-limiting example, the execution component 130 can call or query the containerized application 106 for a version identifier or health status of the package manager 112, and the health report 902 can include such version identifier or health status. Accordingly, the health report 902 can be considered as representing various health-related information of the containerized application in a single, easy-to-understand chart or message.

In various embodiments, the execution component 130 can electronically generate the maintenance call 904, if at least one of the set of pluralities of object-level health statuses 302 specifies unhealthy operation. In various aspects, the maintenance call 904 can be any suitable electronic message or communication that can request or schedule technical maintenance or repair for whichever containerized objects have been determined (e.g., according to the set of pluralities of object-level health statuses 302) to be operating unhealthily. Thus, the user, operator, or client need not be bothered to manually request or schedule maintenance for the containerized application 106.

In some embodiments, the execution component 130 can electronically start from scratch whichever containerized objects have been determined (e.g., according to the set of pluralities of object-level health statuses 302) to be operating unhealthily. This can be considered as an automated attempt to cure or rectify any detected unhealthy operations.

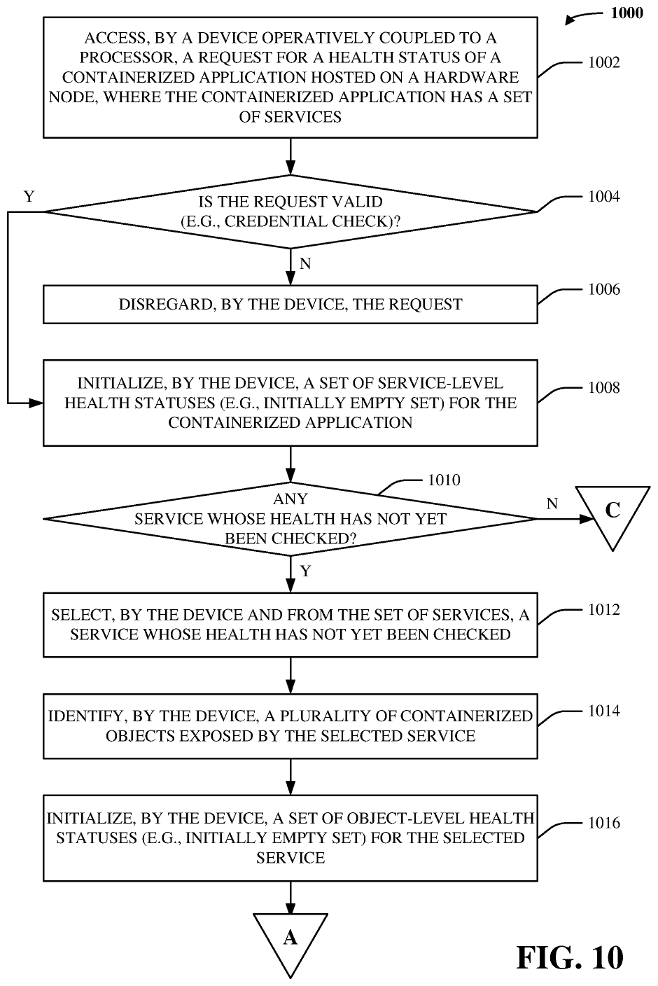

FIGS. 10-13 illustrate flow diagrams of example, non-limiting computer-implemented methods 1000, 1100, 1200, and 1300 that can facilitate composite and reboot-aware health checking of containerized applications in accordance with one or more embodiments described herein. In various cases, the health system 102 can facilitate the computer-implemented methods 1000, 1100, 1200, or 1300.

First, consider FIG. 10. In various embodiments, act 1002 can include accessing, by a device (e.g., via 126) operatively coupled to a processor (e.g., 122), a request (e.g., 116) for a health status of a containerized application (e.g., 106) hosted on a hardware node (e.g., 104). In various cases, the containerized application can have a set of services (e.g., 114).

In various aspects, act 1004 can include determining, by the device (e.g., via 126), whether the request is valid. This can involve credential checking or certificate checking. If the request is not valid, the computer-implemented method 1000 can proceed to act 1006. If the request is valid, the computer-implemented method 1000 can instead proceed to act 1008.

In various instances, act 1006 can include disregarding, by the device (e.g., via 126), the request.

In various cases, act 1008 can include initializing, by the device (e.g., via 128), a set of service-level health statuses (e.g., 502) for the containerized application. In various instances, the set of service-level health statuses can be initially empty.

In various aspects, act 1010 can include determining, by the device (e.g., via 128), whether there is any service of the containerized application whose health has not yet been checked. If not (e.g., if all services have had their health checked), the computer-implemented method 1000 can proceed to act 1302 of the computer-implemented method 1300. If so (e.g., if at least one service has not yet had its health checked), the computer-implemented method 1000 can proceed to act 1012.

In various instances, act 1012 can include selecting, by the device (e.g., via 128) and from the set of services, a service (e.g., 114(n)) whose health has not yet been checked.

In various cases, act 1014 can include identifying, by the device (e.g., via 128), a plurality of containerized objects (e.g., 202(n)) that are exposed by the selected service.

In various aspects, act 1016 can include initializing, by the device (e.g., via 128), a set of object-level health statuses (e.g., 302(n)) for the selected service. In various cases, the set of object-level health statues can be initially empty. In various instances, the computer-implemented method 1000 can proceed to act 1102 of the computer-implemented method 1100.

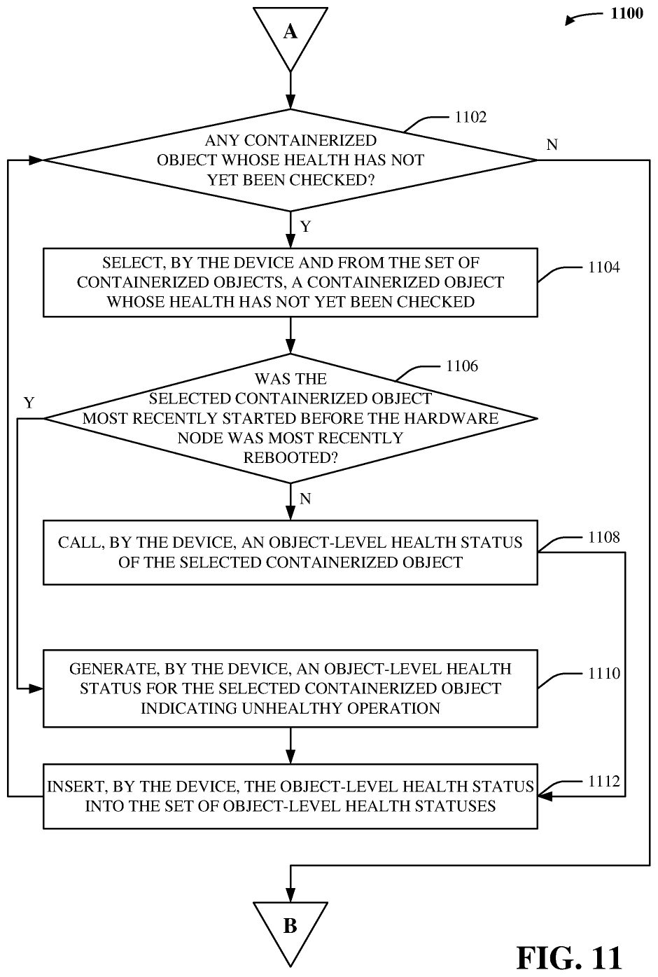

Now, consider FIG. 11. In various embodiments, act 1102 can include determining, by the device (e.g., via 128), whether there is any containerized object exposed by the selected service that has not yet had its health checked. If not (e.g., if all the containerized objects exposed by the selected service have already had their health checked), the computer-implemented method 1100 can proceed to act 1202 of the computer-implemented method 1200. If so (e.g., if at least one containerized object exposed by the selected service has not yet had its health checked), the computer-implemented method 1100 can proceed to act 1104.

In various aspects, act 1104 can include selecting, by the device (e.g., via 128) and from the set of containerized objects exposed by the selected service, a containerized object (e.g., 202(n)(1)) whose health has not yet been checked.

In various instances, act 1106 can include determining, by the device (e.g., via 128), whether the selected containerized object was most recently started from scratch before the hardware node was most recently rebooted. If not (e.g., if the selected containerized object was most recently started from scratch after or later than when the hardware node was most recently rebooted), the computer-implemented method 1100 can proceed to act 1108. If so (e.g., if the selected containerized object was most recently started from scratch before or earlier than when the hardware node was most recently rebooted), the computer-implemented method 1100 can instead proceed to act 1110.

In various cases, act 1108 can include calling or querying, by the device (e.g., via 128), an object-level health status (e.g., 302(n)(1)) of the selected containerized object. Note that such object-level health status can indicate healthy operation or unhealthy operation. In various aspects, the computer-implemented method 1100 can proceed to act 1112.

In various instances, act 1110 can include generating, by the device (e.g., via 128), an object-level health status (e.g., 302(n)(1)) for the selected containerized object that indicates unhealthy operation. In other words, if the selected containerized object was most recently started from scratch earlier than when the hardware node was most recently rebooted, then it cannot be determined that the selected containerized object is operating healthily. Instead, it can only be determined that the selected containerized object is operating unhealthily (e.g., duc to staleness), regardless of what heath status the selected containerized object would return in response to a call or query. In various cases, the computer-implemented method 1100 can proceed to act 1112.

In various aspects, act 1112 can include inserting, by the device (e.g., via 128), the object-level health status (which was generated at act 1108 or 1110) into the set of object-level health statuses. In various cases, the computer-implemented method 1100 can proceed back to act 1102.

Note that acts 1106, 1108, and 1110 can collectively be considered as a reboot-aware health check.

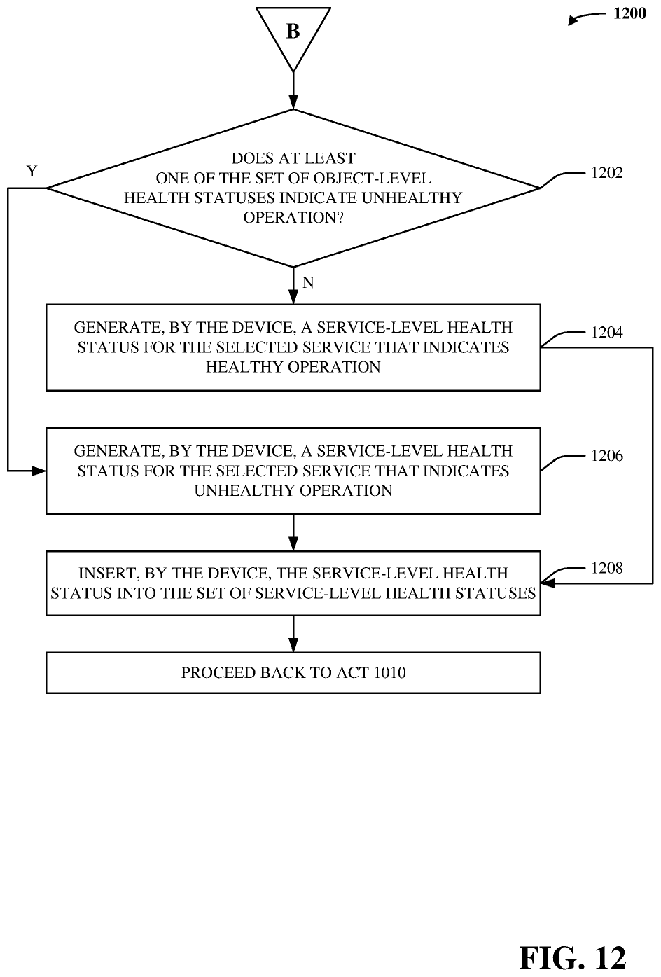

Now, consider FIG. 12. In various embodiments, act 1202 can include determining, by the device (e.g., via 128), whether at least one of the set of object-level health statuses indicates unhealthy operation. If not (e.g., if all of the set of object-level health statuses indicate healthy operation), the computer-implemented method 1200 can proceed to act 1204. If so (e.g., if one or more of the set of object-level health statuses indicate unhealthy operation), the computer-implemented method 1200 can instead proceed to act 1206.

In various aspects, act 1204 can include generating, by the device (e.g., via 128), a service-level health status (e.g., 502(n)) for the selected service that indicates healthy operation. In various cases, the computer-implemented method 1200 can proceed to act 1208.

In various instances, act 1206 can include generating, by the device (e.g., via 128), a service-level health status (e.g., 502(n)) for the selected service that indicates unhealthy operation. In various cases, the computer-implemented method 1200 can proceed to act 1208.

In various aspects, act 1208 can include inserting, by the device (e.g., via 128), the service-level health status (e.g., generated at act 1204 or 1206) into the set of service-level health statuses. In various cases, the computer-implemented method 1200 can proceed back to act 1010.

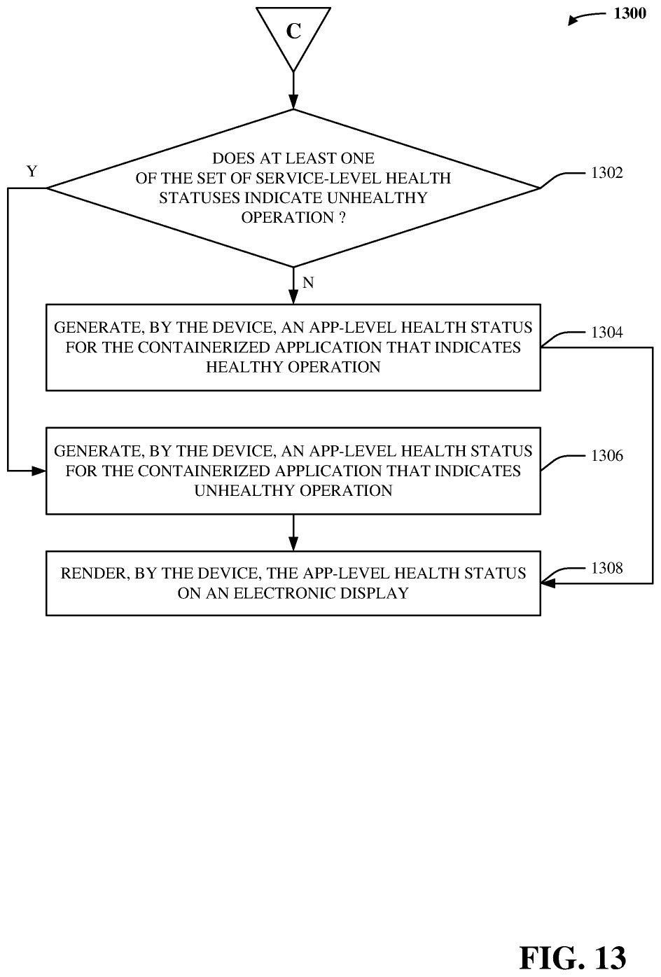

Now, consider FIG. 13. In various embodiments, act 1302 can include determining, by the device (e.g., via 128), whether at least one of the set of service-level health statuses indicates unhealthy operation. If not (e.g., if all of the set of service-level health statuses indicate healthy operation), the computer-implemented method 1300 can proceed to act 1304. If so (e.g., if one or more of the set of service-level health statuses indicate unhealthy operation), the computer-implemented method 1300 can instead proceed to act 1306.

In various aspects, act 1304 can include generating, by the device (e.g., via 128), an app-level health status (e.g., 702) for the containerized application that indicates healthy operation. In various cases, the computer-implemented method 1300 can proceed to act 1308.

In various instances, act 1306 can include generating, by the device (e.g., via 128), an app-level health status (e.g., 702) for the containerized application that indicates unhealthy operation. In various cases, the computer-implemented method 1300 can proceed to act 1308.

In various aspects, act 1308 can include rendering, by the device (e.g., via 130), the app-level health status on an electronic display.

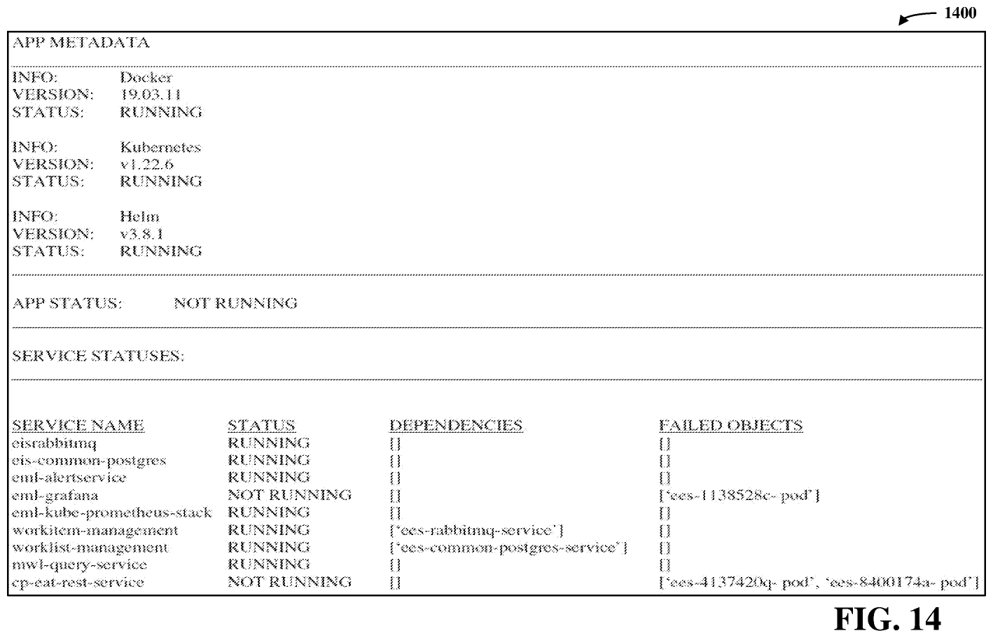

FIG. 14 illustrates an example, non-limiting screenshot 1400 of containerized application health statuses that can be visually rendered in accordance with one or more embodiments described herein. In other words, the screenshot 1400 can be considered as depicting an example, non-limiting embodiment of the health report 902.

In various embodiments, as shown in the screenshot 1400, the health report 902 can include an APP METADATA section that can indicate any suitable metadata pertaining to the containerized application 106 (e.g., pertaining to the orchestration platform 108, to the container runtime 110, or to the package manager 112). As shown in the non-limiting example of FIG. 14, the health report 902 can indicate that the containerized application 106 has Docker version 19.03.11 as its container runtime, Kubernetes version v1.22.6 as its orchestration platform, and Helm version v3.8.1 as its package manager, all of which can be properly installed or otherwise properly functioning (e.g., RUNNING).

In various aspects, as shown in the screenshot 1400, the health report 902 can include an APP STATUS section. In various instances, the APP STATUS section can be considered as indicating or conveying the application-level health status 702. As shown in the non-limiting example of FIG. 14, the health report 902 can indicate that the containerized application 106 is not operating healthily (e.g., NOT RUNNING). This can mean that one or more of the set of services 114 is not operating healthily.

In various cases, as shown in the screenshot 1400, the health report 902 can include a SERVICE STATUSES section. In various aspects, the SERVICE STATUSES section can be considered as indicating or otherwise conveying any of the set of service-level health statuses 502 or any other suitable information pertaining to any of the set of services 114. In particular, as shown in the non-limiting example of FIG. 14, the health report 902 can indicate or list the names or identifiers of various services of the containerized application 106 (e.g., “rabbitmq” can be the name or identifier of a first service, “common-postgres” can be the name or identifier of a second service, “alertservice” can be the name or identifier of a third service). Moreover, as also shown in the non-limiting example of FIG. 14, the health report 902 can indicate the service-level health statuses corresponding to those named or identified services (e.g., the services “rabbitmq” and “kube-prometheus-stack” can be RUNNING, whereas the services “grafana” and “cat-rest-service” can be NOT RUNNING). Furthermore, as also shown in the non-limiting example of FIG. 14, the health report 902 can indicate any dependencies of those named or identified services (e.g., the service “workitem-management” can depend upon the service “rabbitmq”; the service “worklist-management” can depend upon the service “common-postgres”). Further still, as shown in the non-limiting example of FIG. 14, the health report 902 can indicate which specific containerized objects, if any, of those named or identified services have been determined to be operating unhealthily (e.g., the pod “1138528c” of the service “grafana” has been determined, in reboot-aware fashion, to be NOT RUNNING; the pods “4137420q” and “8400174a” of the service “cat-rest-service” have been determined, in reboot-aware fashion, to be NOT RUNNING).

Accordingly, as shown in FIG. 14, the health report 902 can, in various embodiments, be considered as a collective, composite, or aggregated chart that can visually indicate high-level status information regarding the containerized application 106 (e.g., APP METADATA, APP STATUS) as well as more granular or detailed status information regarding the containerized application 106 (e.g., SERVICE STATUSES, FAILED OBJECTS). Thus, a technician who is tasked with overseeing or maintaining the containerized application 106 can quickly and easily learn which, if any, specific services or specific containerized objects have been determined to not be operating healthily. The technician can learn such information without having to manually and aimlessly check the health statuses of each containerized object. Additionally, because the health report 902 can have been generated in reboot-aware fashion as described herein, the health report 902 can be unaffected by the reboot-staleness problem mentioned above, meaning that the health report 902 can have a higher level of confidence or reliability.

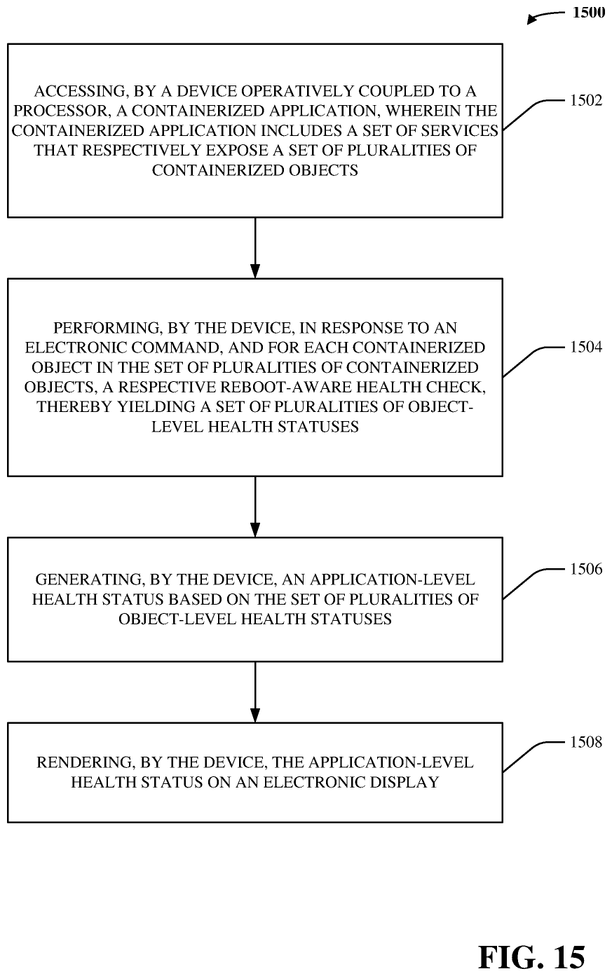

FIG. 15 illustrates a flow diagram of an example, non-limiting computer-implemented method 1500 that can facilitate composite and reboot-aware health checking of containerized applications in accordance with one or more embodiments described herein. In various cases, the health system 102 can facilitate the computer-implemented method 1500.

In various embodiments, act 1502 can include accessing, by a device (e.g., via 126) operatively coupled to a processor (e.g., 122), a containerized application (e.g., 106). In various cases, the containerized application can include a set of services (e.g., 114) that respectively expose a set of pluralities of containerized objects (e.g., 202).

In various aspects, act 1504 can include performing, by the device (e.g., via 128), in response to an electronic command (e.g., 116), and for each containerized object in the set of pluralities of containerized objects, a respective reboot-aware health check, thereby yielding a set of pluralities of object-level health statuses (e.g., 302).

In various instances, act 1506 can include generating, by the device (e.g., via 128), an application-level health status (e.g., 702) based on the set of pluralities of object-level health statuses.

In various cases, act 1508 can include rendering, by the device (e.g., via 130), the application-level health status on an electronic display.

Although not explicitly shown in FIG. 15, the computer-implemented method 1500 can comprise generating, by the device (e.g., via 128), a set of service-level health statuses (e.g., 502) respectively based on the set of pluralities of object-level health statuses, wherein the application-level health status can be based on the set of service-level health statuses.

Although not explicitly shown in FIG. 15, a first service-level health status (e.g., 502(1)) of the set of service-level health statuses can be based on a first plurality of object-level health statuses (e.g., 302(1)) of the set of pluralities of object-level health statuses; the device can cause the first service-level health status to indicate healthy operation in response to all of the first plurality of object-level health statuses indicating healthy operation (e.g., as described with respect to FIG. 6); and the device can cause the first service-level health status to indicate unhealthy operation in response to at least one of the first plurality of object-level health statuses indicating unhealthy operation (e.g., as described with respect to FIG. 6).

Although not explicitly shown in FIG. 15, the device can cause the application-level health status to indicate healthy operation in response to all of the set of service-level health statuses indicating healthy operation (e.g., as described with respect to FIG. 8), and the device can cause the application-level health status to indicate unhealthy operation in response to at least one of the set of service-level health statuses indicating unhealthy operation (e.g., as described with respect to FIG. 8).

Although not explicitly shown in FIG. 15, the application-level health status can indicate unhealthy operation, and the computer-implemented method 1500 can comprise rendering, by the device (e.g., via 130) and on the electronic display, an electronic message (e.g., 902) indicating which of the set of pluralities of containerized objects are operating unhealthily.

Although not explicitly shown in FIG. 15, the computer-implemented method 1500 can comprise scheduling or requesting, by the device (e.g., via 130), maintenance (e.g., 904) of the containerized application in response to the application-level health status indicating unhealthy operation.

Although not explicitly shown in FIG. 15, a first containerized object (e.g., 202(1)(1)) of the set of pluralities of containerized objects can correspond to a first object-level health status (e.g., 302(1)(1)) in the set of pluralities of object-level health statuses, a hardware node (e.g., 104) can host the containerized application, and the first object-level health status can indicate unhealthy operation if a most-recent start date of the first containerized object pre-dates a most-recent reboot date (e.g., 120) of the hardware node (e.g., as described with respect to FIG. 4).

Although not explicitly shown in FIG. 15, the containerized application can be orchestrated by Kubernetes, and the hardware node can be a medical imaging scanner.

Although the herein disclosure mainly describes various embodiments of the containerized application 106 as being wholly hosted by the hardware node 104, this is a mere non-limiting example for case of explanation and illustration. In various aspects, the containerized application 106 can be hosted in distributed fashion across any suitable number of hardware nodes or cloud servers. In such case, a reboot-aware health check performed on any given containerized object can be performed with respect to the last reboot time of whichever particular hardware node or cloud server hosts that given containerized object.

Accordingly, various embodiments described herein can be considered as a computerized tool for performing composite and reboot-aware health checks on containerized applications. Such a computerized tool can reduce an amount of time or effort that would otherwise be expended by users, operators, or clients. Additionally, such a computerized tool can address the problem of reboot staleness as described herein, which problem was not even recognized by existing containerization techniques. Thus, various embodiments described herein certainly constitute useful and practical applications of computers.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For case of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

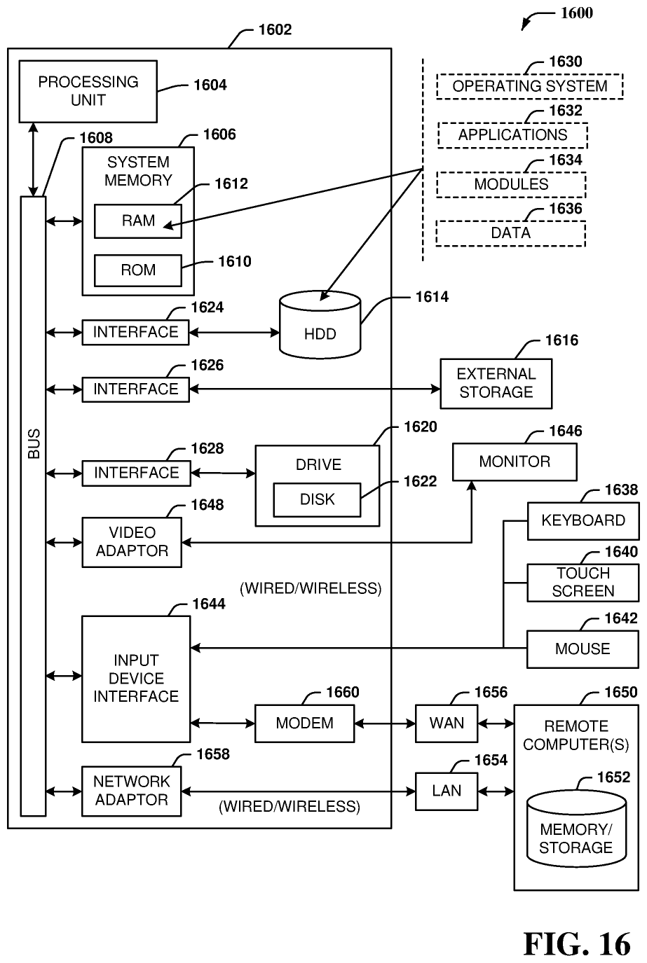

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the aspects described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD) 1616, a memory stick or flash drive reader, a memory card reader, etc.) and a drive 1620, e.g., such as a solid state drive, an optical disk drive, which can read or write from a disk 1622, such as a CD-ROM disc, a DVD, a BD, etc. Alternatively, where a solid state drive is involved, disk 1622 would not be included, unless separate. While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and drive 1620 can be connected to the system bus 1608 by an HDD interface 1624, an external storage interface 1626 and a drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above, such as but not limited to a network virtual machine providing one or more aspects of storage or processing of information. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

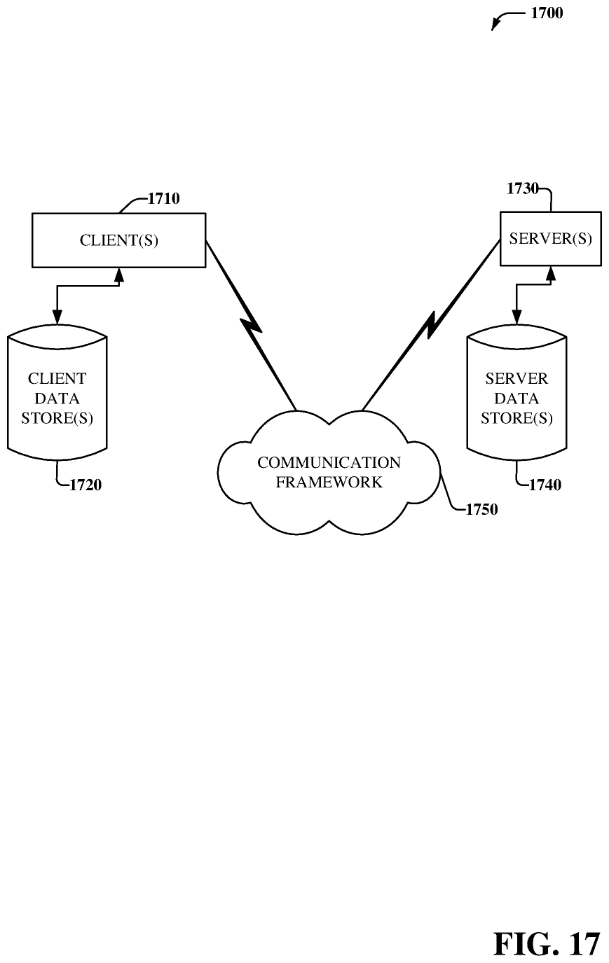

FIG. 17 is a schematic block diagram of a sample computing environment 1700 with which the disclosed subject matter can interact. The sample computing environment 1700 includes one or more client(s) 1710. The client(s) 1710 can be hardware or software (e.g., threads, processes, computing devices). The sample computing environment 1700 also includes one or more server(s) 1730. The server(s) 1730 can also be hardware or software (e.g., threads, processes, computing devices). The servers 1730 can house threads to perform transformations by employing one or more embodiments as described herein, for example. One possible communication between a client 1710 and a server 1730 can be in the form of a data packet adapted to be transmitted between two or more computer processes. The sample computing environment 1700 includes a communication framework 1750 that can be employed to facilitate communications between the client(s) 1710 and the server(s) 1730. The client(s) 1710 are operably connected to one or more client data store(s) 1720 that can be employed to store information local to the client(s) 1710. Similarly, the server(s) 1730 are operably connected to one or more server data store(s) 1740 that can be employed to store information local to the servers 1730.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations. including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, the computer-executable components comprising:
an access component that accesses a containerized application, wherein the containerized application includes a set of services that respectively expose a set of pluralities of containerized objects;
a status component that performs, in response to an electronic command and for each containerized object in the set of pluralities of containerized objects, a respective reboot-aware health check, thereby yielding a set of pluralities of object-level health statuses, and generates an application-level health status based on the set of pluralities of object-level health statuses; and
an execution component that renders the application-level health status on an electronic display.

2. The system of claim 1, wherein the status component generates a set of service-level health statuses respectively based on the set of pluralities of object-level health statuses, and wherein the status component generates the application-level health status based on the set of service-level health statuses.

3. The system of claim 2, wherein a first service-level health status of the set of service-level health statuses is based on a first plurality of object-level health statuses of the set of pluralities of object-level health statuses, wherein the status component causes the first service-level health status to indicate healthy operation in response to all of the first plurality of object-level health statuses indicating healthy operation, and wherein the status component causes the first service-level health status to indicate unhealthy operation in response to at least one of the first plurality of object-level health statuses indicating unhealthy operation.

4. The system of claim 3, wherein the status component causes the application-level health status to indicate healthy operation in response to all of the set of service-level health statuses indicating healthy operation, and wherein the status component causes the application-level health status to indicate unhealthy operation in response to at least one of the set of service-level health statuses indicating unhealthy operation.

5. The system of claim 4, wherein the application-level health status indicates unhealthy operation, and wherein the execution component renders, on the electronic display, an electronic message indicating which of the set of pluralities of containerized objects are operating unhealthily.

6. The system of claim 1, wherein the execution component schedules or requests maintenance of the containerized application in response to the application-level health status indicating unhealthy operation.

7. The system of claim 1, wherein a first containerized object of the set of pluralities of containerized objects corresponds to a first object-level health status in the set of pluralities of object-level health statuses, wherein a hardware node hosts the containerized application, and wherein the first object-level health status indicates unhealthy operation if a most-recent start date of the first containerized object pre-dates a most-recent reboot date of the hardware node.

8. The system of claim 7, wherein the containerized application is orchestrated by Kubernetes, and wherein the hardware node is a medical imaging scanner.

9. A computer-implemented method, comprising:
accessing, by a device operatively coupled to a processor, a containerized application, wherein the containerized application includes a set of services that respectively expose a set of pluralities of containerized objects;
performing, by the device, in response to an electronic command, and for each containerized object in the set of pluralities of containerized objects, a respective reboot-aware health check, thereby yielding a set of pluralities of object-level health statuses;
generating, by the device, an application-level health status based on the set of pluralities of object-level health statuses; and
rendering, by the device, the application-level health status on an electronic display.

10. The computer-implemented method of claim 9, further comprising:
generating, by the device, a set of service-level health statuses respectively based on the set of pluralities of object-level health statuses, wherein the application-level health status is based on the set of service-level health statuses.

11. The computer-implemented method of claim 10, wherein a first service-level health status of the set of service-level health statuses is based on a first plurality of object-level health statuses of the set of pluralities of object-level health statuses, wherein the device causes the first service-level health status to indicate healthy operation in response to all of the first plurality of object-level health statuses indicating healthy operation, and wherein the device causes the first service-level health status to indicate unhealthy operation in response to at least one of the first plurality of object-level health statuses indicating unhealthy operation.

12. The computer-implemented method of claim 11, wherein the device causes the application-level health status to indicate healthy operation in response to all of the set of service-level health statuses indicating healthy operation, and wherein the device causes the application-level health status to indicate unhealthy operation in response to at least one of the set of service-level health statuses indicating unhealthy operation.

13. The computer-implemented method of claim 12, wherein the application-level health status indicates unhealthy operation, and further comprising:
rendering, by the device and on the electronic display, an electronic message indicating which of the set of pluralities of containerized objects are operating unhealthily.

14. The computer-implemented method of claim 9, further comprising:
scheduling or requesting, by the device, maintenance of the containerized application in response to the application-level health status indicating unhealthy operation.

15. The computer-implemented method of claim 9, wherein a first containerized object of the set of pluralities of containerized objects corresponds to a first object-level health status in the set of pluralities of object-level health statuses, wherein a hardware node hosts the containerized application, and wherein the first object-level health status indicates unhealthy operation if a most-recent start date of the first containerized object pre-dates a most-recent reboot date of the hardware node.

16. The computer-implemented method of claim 15, wherein the containerized application is orchestrated by Kubernetes, and wherein the hardware node is a medical imaging scanner.

17. A computer program product for facilitating composite and reboot-aware health checking of containerized applications, the computer program product comprising a non-transitory computer-readable memory having program instructions embodied therewith, the program instructions executable by a processor to cause the processor to:
access a containerized application hosted on a medical imaging scanner, wherein the containerized application includes a set of services that respectively expose a set of pluralities of containerized objects;
perform, in response to an electronic command and for each containerized object in the set of pluralities of containerized objects, a respective health check that takes into account a most-recent reboot time of the medical imaging scanner, thereby yielding a set of pluralities of object-level health statuses; and
generate a health report based on the set of pluralities of object-level health statuses.

18. The computer program product of claim 17, wherein the health report indicates which, if any, of the set of pluralities of object-level health statuses indicate unhealthy operation.

19. The computer program product of claim 17, wherein a first containerized object of the set of pluralities of containerized objects corresponds to a first object-level health status in the set of pluralities of object-level health statuses, and wherein the first object-level health status indicates unhealthy operation if a most-recent start time of the first containerized object pre-dates the most-recent reboot time of the medical imaging scanner.

20. The computer program product of claim 17, wherein the containerized application is orchestrated by Kubernetes.
